(19) United States
(12) Patent Application Publication
(10) Pub. No.: US 2023/0010766 A1
(43) Pub. Date: Jan. 12, 2023

(54) SECUREMENT SYSTEM FOR SECURING CARGO IN AND TO A CARGO AREA OF A MOTOR VEHICLE

(71) Applicant: INDIANA MILLS & MANUFACTURING, INC., Westfield, IN (US)

(72) Inventor: Jeffrey A. KING, Markleville, IN (US)

(21) Appl. No.: 17/635,922

(22) PCT Filed: Aug. 31, 2020
(86) PCT No.: PCT/US2020/048729

§ 371 Date: Feb. 16, 2022

Related U.S. Application Data
(60) Provisional application No. 62/894,089, filed on Aug. 30, 2019.

(51) Int. Cl. B60P 7/08; B65H 75/44; B65H 75/42

(52) U.S. Cl. CPC B60P 7/083; B60P 7/0815; B60P 7/0846; B65H 75/425; B65H 75/4431; B65H 2701/375

(57) ABSTRACT

A cargo securement system for securing cargo items in and to a cargo area of a motor vehicle may include at least one elongated support rail configured to be mounted to and to extend along at least a portion of a length of an inner wall of the at least one of a side, front or rear of the cargo area of the motor vehicle, and at least one cargo restraint module configured to be releasably secured to the at least one elongated support rail, at least a first portion of the at least once cargo restraint module configured to releasably engage at least one cargo item to restrain the at least one cargo item to and within the cargo area of the motor vehicle.

### CROSS-REFERENCE TO RELATED APPLICATION

This patent application claims the benefit of and priority to U.S. Provisional Pat. Application Ser. No. 62/894,089, filed Aug. 30, 2019, the disclosure of which is expressly incorporated herein by reference in its entirety.

### FIELD OF THE INVENTION

The present invention relates generally to restraint systems for motor vehicles, and more specifically to cargo securement systems mountable to or integral with a cargo area of a motor vehicle such as, but not limited to, a bed of a pickup truck.

### BACKGROUND

Conventional motor vehicles may be equipped with one or more restraint devices configured to secure passengers and/or cargo in a motor vehicle. Such restraint devices may or may not be web-based, and some such web-based devices may include one or more web retractors.

### SUMMARY

The present disclosure may comprise one or more of the features recited in the attached claims, and/or one or more of the following features and combinations thereof. In one aspect, a securement system for securing cargo items in and to a cargo area of a motor vehicle may comprise an elongated support rail configured to be mounted to an inner wall of any of a side, front or rear of the cargo area of the motor vehicle, the elongated support rail extending along at least a portion of a length of the inner wall, and a cargo restraint module securable to the support rail at any of a plurality of positions along the support rail, the cargo restraint module including a mounting assembly configured to be releasably secured to the support rail, and a web retractor attached to the mounting assembly, the web retractor configured to pay out and take up a flexible web coupled thereto.

In another aspect, a cargo securement system for securing cargo items in and to a cargo area of a motor vehicle may comprise at least one lattice structure configured to be mounted to, or to define, an inner wall of at least one of a side, front or rear of the cargo area of the motor vehicle, the at least one lattice structure defining a plurality of openings therethrough, and at least one cargo restraint module configured to be releasably secured to the at least one lattice structure with at least a first portion of the at least one cargo restraint module extending through at least one of any of the plurality of openings defined through the at least one lattice structure and engaging the at least one lattice structure at least partially about the at least one of the plurality of openings, at least a second portion of the at least one cargo restraint module configured to releasably engage at least one cargo item to restrain the at least one cargo item to and within the cargo area of the motor vehicle.

In a further aspect, a cargo securement system for securing cargo items in and to a cargo area of a motor vehicle may comprise at least one elongated support rail configured to be mounted to and to extend along at least a portion of a length of an inner wall of the at least one of a side, front or rear of the cargo area of the motor vehicle, and at least one cargo restraint module configured to be releasably secured to the at least one elongated support rail, at least a first portion of the at least once cargo restraint module configured to releasably engage at least one cargo item to restrain the at least one cargo item to and within the cargo area of the motor vehicle.

In yet another aspect, a securement system for securing cargo items in and to a cargo area of a motor vehicle may comprise a cargo restraint module configured to be secured at any of a plurality of positions to and along an elongated support rail mounted in a cargo area of a motor vehicle, the cargo restraint module including a mounting assembly configured to be releasably secured to the elongated support rail, and a web retractor attached to the mounting assembly, the web retractor configured to pay out and take up a flexible web coupled thereto.

### BRIEF DESCRIPTION OF THE DRAWINGS

This disclosure is illustrated by way of example and not by way of limitation in the accompanying figures. Where considered appropriate, reference labels have been repeated among the Figures to indicate corresponding or analogous elements.

FIG. 1 is a perspective view of an embodiment of a cargo securement system including an embodiment of a restraint module support structure in the form of a first embodiment of a support rail secured to and along at least one inner side of a truck bed, and also including an embodiment of a cargo restraint module partially mounted thereto.

FIG. 2 is a perspective view similar to FIG. 1 shown with the cargo restraint module securely mounted to the support rail.

FIG. 3A is a cross-sectional view of a portion of the cargo securement system of FIG. 1, as viewed along section lines 3A-3A thereof, illustrating the cargo restraint module partially mounted to the support rail.

FIG. 3B is a cross-sectional view of a portion of the cargo securement system of FIG. 2, as viewed along section lines 3B-3B thereof, illustrating the cargo restraint module securely mounted to the support rail.

FIG. 4 is a perspective view of the cargo securement system of FIG. 1-3B showing the cargo restraint module moved to a use position from its stored position illustrated in FIGS. 1 and 2.

FIG. 5 is a perspective view of another embodiment of a cargo securement system including another embodiment of a cargo module support structure in the form of a second embodiment of a support rail and an embodiment of a lattice structure each secured to and along at least one inner side of a truck bed, and showing some example embodiments of various different cargo restraint modules mounted thereto.

FIGS. 6A and 6B are magnified perspective views of a portion of the support rail of FIG. 5 illustrating movable mounting and positioning of a cargo restraint module therealong.

FIG. 7 is a perspective view of a third embodiment of a support rail securable to and along at least one inner side of a truck bed, and configured for movably mounting a cargo restraint module thereto.

FIG. 8 is a perspective view of another embodiment of a cargo restraint module movably mounted and selectively securable to the support rail of FIG. 7.

FIG. 9A is a perspective view similar to FIG. 8 but with the cover removed from the cargo restraint module to illustrate an embodiment of a mounting arrangement securing the cargo restraint module to the support rail at an example discrete location defined along the rail.

FIG. 9B is a perspective view similar to FIG. 9A but with the support rail omitted to illustrate further details of the mounting arrangement in the rail secured state shown in FIG. 9A.

FIG. 9C is a cross-sectional view, as viewed along section lines 9C-9C of FIG. 9A, illustrating the mounting arrangement in the rail secured state to secure the cargo restraint module to the support rail at the example discrete location along the support rail.

FIG. 10A is a perspective view similar to FIG. 9A but with the mounting arrangement manually manipulated to release the cargo restraint module from the discrete location of FIGS. 9A and 9C so as to be slidable in and along the channel of the support rail.

FIG. 10B is a perspective view similar to FIG. 10A but with the support rail omitted to illustrate further details of the mounting arrangement in the rail release state shown in FIG. 10A.

FIG. 10C is a cross-sectional view, as viewed along section lines 10C-10C of FIG. 10A, illustrating the mounting arrangement in the rail release state to allow the cargo restraint module to slide in and along the channel of the support rail.

FIG. 11 is a perspective view of yet another embodiment of a cargo restraint module movably mounted and selectively secured to the support rail of FIG. 7 at an example discrete location defined along the rail.

FIG. 12 is a perspective view similar to FIG. 11 but with the support rail omitted to illustrate further details of the mounting arrangement in the rail secured state shown in FIG. 11.

FIG. 13 is a cross-sectional view, as viewed along section lines 13-13 of FIG. 11, illustrating the mounting arrangement in the rail secured state to secure the cargo restraint module to the support rail at the example discrete location along the support rail.

FIG. 14 is a cross-sectional view similar to FIG. 13 but with the mounting arrangement manually manipulated to release the cargo restraint module from the discrete location of FIGS. 11 and 13 so as to be slidable in and along the channel of the support rail.

FIG. 15A is a front perspective view of yet another embodiment of a cargo restraint module selectively securable to the lattice structure illustrated in FIG. 5.

FIG. 15B is a front elevational view of the cargo restraint module of FIG. 15A.

FIG. 15C is a cross-sectional view of the cargo restraint module of FIGS. 15A and 15B as viewed along section lines 15C-15C of FIG. 15B.

FIG. 15D is a cross-sectional view similar to FIG. 15C and showing the cargo restraint module in an engaged position relative to the lattice structure.

FIG. 15E is a front perspective view showing the cargo restraint module of FIGS. 15A-15D in the engaged position relative to the lattice structure.

FIG. 16A is a front perspective view of still another embodiment of a cargo restraint module selectively securable to the lattice structure illustrated in FIG. 5.

FIG. 16B is a rear elevational view of the cargo restraint module of FIG. 16B illustrating mounting brackets of the module passing through openings defined through the lattice structure.

FIG. 16C is a front elevational view of the cargo restraint module of FIGS. 16A and 16B engaged with the lattice structure.

FIG. 16D is a cross-sectional view of the cargo restraint module of FIGS. 16A-16C as viewed along section lines 16D-16D of FIG. 16C.

FIG. 16E is a cross-sectional view similar to FIG. 16D and showing the cargo restraint module in an disengaged position relative to the lattice structure.

FIG. 16F is a front perspective view showing the cargo restraint module of FIGS. 16A-16E in the engaged position relative to the lattice structure.

FIG. 16G is a rear perspective view showing the cargo restraint module of FIGS. 16A-16F in the engaged position relative to the lattice structure.

FIG. 17 is a front perspective view of a further embodiment of a cargo restraint module secured to the lattice structure illustrated in FIG. 5.

FIG. 18A is a front perspective view of yet another embodiment of a cargo restraint module secured to the lattice structure illustrated in FIG. 5.

FIG. 18B is a front perspective view similar to FIG. 18A showing the cargo restraint module of FIG. 18A restraining a specific cargo component.

FIG. 19A is a front perspective view of yet another embodiment of a cargo restraint module secured to the lattice structure illustrated in FIG. 5.

FIG. 19B is a top plan view of the cargo restraint module of FIG. 19A shown with a corresponding cargo component received thereby.

FIG. 19C is a magnified perspective view of a portion of the module illustrated in FIGS. 19A and 19B showing securement of the cargo component thereto.

FIG. 20A is a perspective view of still a further example embodiment of a cargo restraint module mounted to the lattice structure of FIG. 5.

FIGS. 20B-20D are magnified perspective views of one component of the module of FIG. 20A shown progressively securing a corresponding cargo component thereto.

FIG. 21 is a rear plan view of a bed of a pickup truck illustrating still a another example embodiment of a cargo restraint module coupled to and between opposing lattice structures each mounted to and along a respective inner side of a truck bed.

FIG. 22A is a front perspective view of yet another example embodiment of a cargo restraint module mounted to the lattice structure of FIG. 5.

FIG. 22B is a front perspective view of the cargo restraint module of FIG. 22A shown being mounted to the lattice structure.

FIG. 22C is a front elevational view of the cargo restraint module of FIGS. 22A-22B.

FIG. 22D is a cross-sectional view of the cargo restraint module of FIGS. 22A-22C as viewed along section lines 22D-22D of FIG. 22C and showing the cargo restraint module being mounted to the lattice structure.

FIG. 22E is a cross-sectional view similar to FIG. 22D and showing the cargo restraint module fully engaged with the lattice structure.

FIG. 22F is a front perspective view of the cargo restraint module of FIGS. 22A-22E showing the cargo restraint module fully engaged with the lattice structure.

FIG. 23A is a perspective view of still another embodiment of a cargo restraint module configured to be mounted to the lattice structure of FIG. 5.

FIG. 23B is a front perspective view of the cargo restraint module of FIG. 23A being mounted to the lattice structure of FIG. 5.

FIG. 23C is a front elevational view of the cargo restraint module of FIGS. 23A and 23B.

FIG. 23D is a cross-sectional view of the cargo restraint module of FIGS. 23A-23C as viewed along section lines 23D-23D of FIG. 23C and showing the cargo restraint module being mounted to the lattice structure.

FIG. 23E is a front perspective view of the cargo restraint module of FIGS. 23A-23D shown mounted to the lattice structure.

FIG. 23F is a front elevational view of the cargo restraint module of FIGS. 23A-23E shown mounted to the lattice structure.

FIG. 23G is a cross-sectional view of the cargo restraint module of FIG. 23F as viewed along section lines 23G-23G thereof.

FIG. 23H is a cross-sectional view of the cargo restraint module of FIG. 23F as viewed along section lines 23H-23H thereof.

FIG. 24A is a perspective view of still a further embodiment of a cargo restraint module configured to be mounted to the lattice structure of FIG. 5.

FIG. 24B is a front perspective view of the cargo restraint module of FIG. 24A mounted to the lattice structure of FIG. 5.

FIG. 24C is a front elevational view of the cargo restraint module of FIGS. 24A and 24B.

FIG. 24D is a cross-sectional view of the cargo restraint module of FIG. 24C as viewed along section lines 24D-24D thereof.

FIG. 24E is a cross-sectional view of the cargo restraint module of FIG. 24C as viewed along section lines 24E-24E thereof

FIG. 24F is a cross-sectional view similar to FIG. 24D and showing disengagement of the cargo restraint module from the lattice structure.

FIG. 24G is a cross-sectional view similar to FIG. 24E and showing disengagement of the cargo restraint module from the lattice structure.

### DETAILED DESCRIPTION OF THE DRAWINGS

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

This disclosure relates to various embodiments of a cargo securement system for securing cargo items in and to a truck bed or other cargo area of a motor vehicle. Referring now to FIGS. 1-4, an embodiment is shown of a cargo securement system 10 mounted to a truck bed 16 of a pickup truck. It will be understood that the truck bed 16 is illustrated only by way of example, and that the cargo securement system 10 may alternatively be mounted to a cargo area of any motor vehicle having a cargo area supported by the frame of the motor vehicle, i.e., an “over-the-wheels” cargo area. Examples of such motor vehicles having cargo areas may include, but are not limited to, full-size, mid-size or compact pickup trucks, sport utility vehicles, outdoor utility vehicles, all-terrain vehicles, all-terrain utility vehicles, off-road vehicles, military vehicles, automotive coupe utility vehicles, golf carts, and the like. In any case, the cargo securement system 10 illustrated in FIGS. 1-4 includes a cargo restraint module support structure 11 in the form of an elongated support rail 12 affixed to one side 16A of the truck bed 16 via a plurality of conventional fasteners 14, e.g., screws, nut-bolt combinations, or the like, and at least one cargo restraint module 18 detachably mountable to the support rail 12.

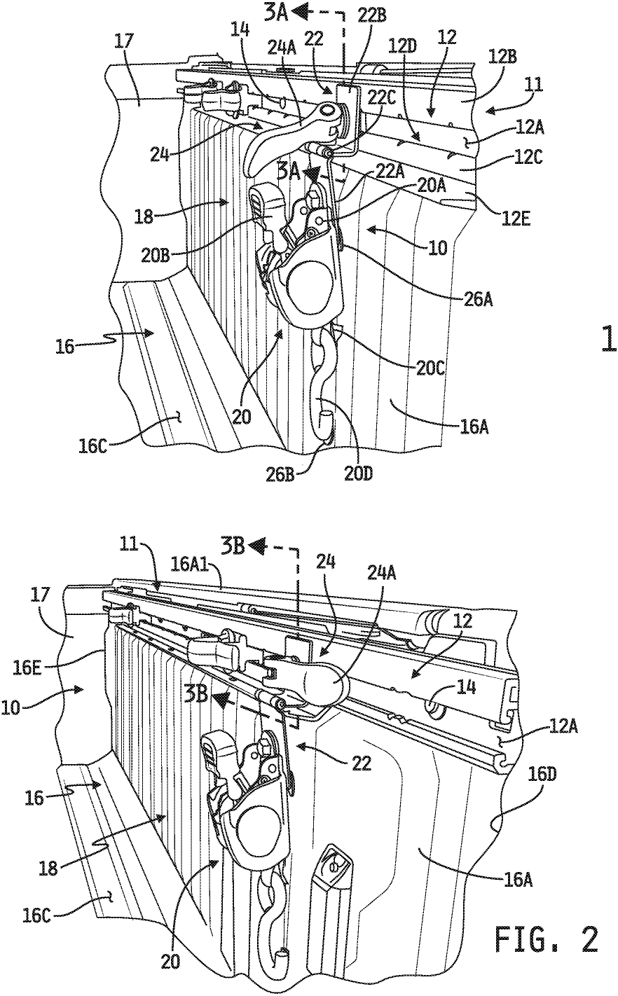

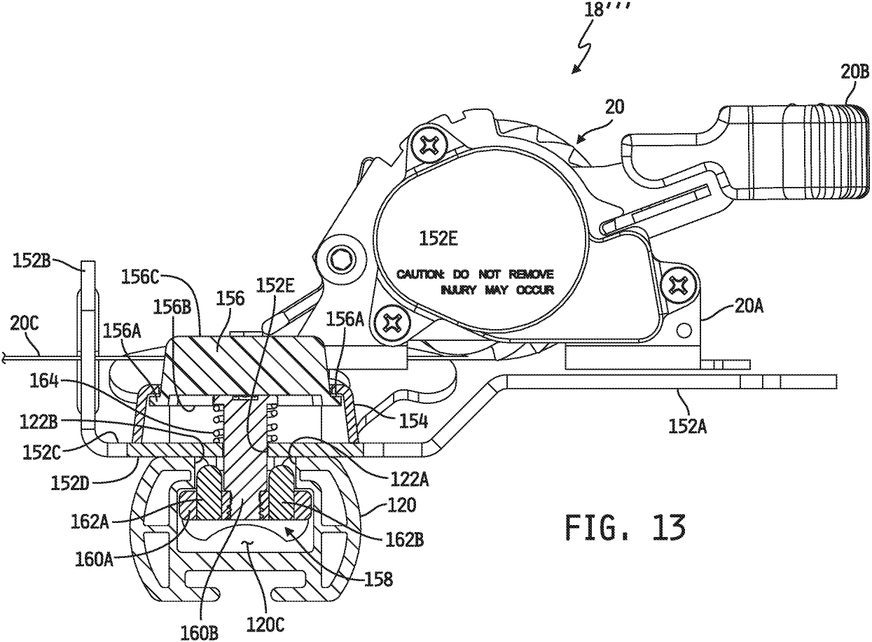

In the illustrated embodiment, the support rail 12 is affixed to an inner wall of one side 16A of the truck bed 16 adjacent to, and parallel with, the top edge or lip 16A1 of the truck bed 16. In alternate embodiments, the support rail 12 may be affixed to the side wall 16A at any location between the bottom 16C of the truck bed and the top 16A1 of the side wall 16A and/or with any orientation relative to the bottom 16C of the truck bed 16 or relative to the top 16A1 of the side wall 16A. As most clearly shown in FIG. 2, the length of the example support rail 12 is sized to span the length of the truck bed side wall 16A, i.e., between a front 16D of the truck bed 16 and a rear 16E of the truck bed 16, although in alternate embodiments the support rail 12 may be shorter than the length of the side wall 16A and may be mounted at any position along the side wall 16A, e.g., centrally, offset to one side or the other, etc. In any case, although only one support rail 12 is shown mounted to the side wall 16A, the support rail 12 may, in alternate embodiments, take the form of two or more support rails 12 mounted end-to-end to the side wall 16A or each with any orientation relative to the side wall 16A. It will be understood that while a support rail 12 is illustrated in FIGS. 1-4 as being mounted only to one side 16A of the truck bed 16, one or more support rails 12 may additionally be mounted to the opposite side 16B of the truck bed 16 (see, e.g., FIG. 13), to the front 16D of the truck bed 16, e.g., behind the cab area in embodiments in which the motor vehicle is a pickup truck or other vehicle having a cab area in front of the bed 16, and/or to the rear 16E of the truck bed, e.g., to a tailgate 17 in embodiments in which the motor vehicle includes a tailgate.

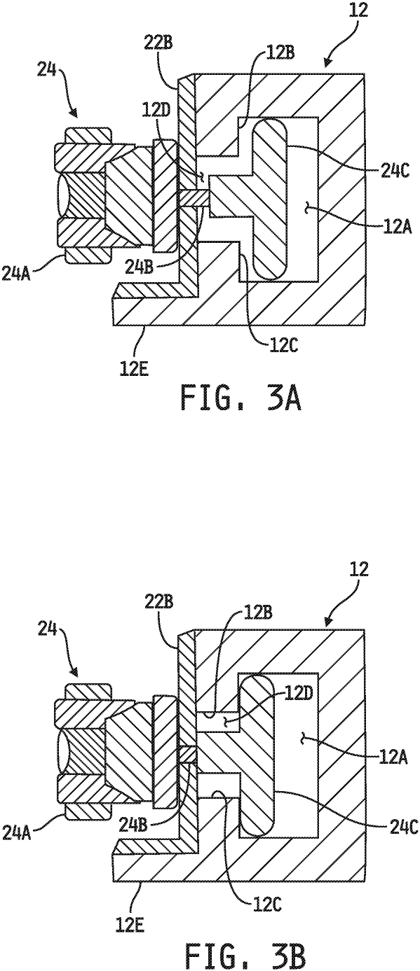

In the embodiment illustrated in FIGS. 1-4, the support rail 12 is illustratively a conventional rigid structure defining a channel 12A therein along its length. In one embodiment, the support rail 12 is formed of aluminum, although in other embodiments the support rail 12 may be form of one or more additional and/or alternate, conventional materials such as steel, a rigid thermoplastic or thermosetting material and/or one or more other suitable material(s). As most clearly shown in FIGS. 3A and 3B, the channel 12A of the support rail 12 is illustratively a C-shaped channel having opposing flanges 12B, 12C defining an opening 12D therebetween that defines an opening to the channel 12A. In some embodiments, the support rail 12 may further include a support flange 12E extending perpendicularly away from the outer surface of the flange 12C to form a support rim or floor of the rail 12. In some embodiments, the support flange 12E may be omitted in its entirety or in selected locations along the rail 12 and/or selectively truncated in its entirety or in selected locations along the rail 12.

In the illustrated embodiment, an embodiment of the cargo restraint module 18 illustratively includes a ratcheting web retractor 20, e.g., sometimes referred to as a “cargo buckle,” affixed to a bracket 22, and a mounting assembly 24 for detachably mounting and securing the bracket 22 to the support rail 12. The retractor 20 illustratively includes a frame 20A to which a ratcheting handle 20B and one end of a web 20C are operatively mounted, and the handle 20B is illustratively movable toward and away from the frame 20A in a conventional manner to ratchet the web 20C in a take-up direction to incrementally draw the web 20C into the retractor 20 in a manner which prohibits release of the web 20C from the retractor 20 in an opposite web payout direction. The retractor 20 is illustratively configured in a conventional manner to allow for release of the web 20C therefrom to allow the web to be drawn from the retractor 20 by applying a suitable force to the opposite end of the web in the web payout direction. In the illustrated embodiment, an engagement structure 20D, e.g., a hook, is attached to the free end of the web 20C to provide for attachment of the free end of the web 20C to a suitably configured structure. When so drawn from the retractor 20, the web 20C may be extended over or about cargo disposed in the truck bed 16. The engagement structure 20D may then be attached to a stationary structure, e.g., mounted to the rail 12, mounted to another rail secured to the truck bed 16 or otherwise defined by or mounted to the truck bed 16, and the handle 20B may be subsequently ratcheted as just described to draw the web 20C into engagement with the cargo and thereby secure the cargo in the truck bed 16 in a conventional manner.

In the illustrated embodiment, the bracket 22 is provided in the form of a hinged plate having a retractor mounting section 22A to which the frame 20A of the retractor 20 is mounted and secured, and a truck bed mounting section 22B to which the mounting assembly 24 is mounted. A conventional hinge 22C is coupled to and between opposed ends of the sections 22A, 22B to allow the sections 22A, 22B to rotate or pivot relative to one another. In some alternate embodiments, the hinge 22C may be omitted such that the sections 22A, 22B are not rotatable or pivotable relative to one another. In some embodiments, one or more other non-hinging but otherwise movable structures may be defined by or coupled to the sections 22A, 22B to provide for movement of the sections 22A, 22B relative to one another.

The mounting assembly 24 illustratively includes a handle 24A operatively coupled to one end of a post or other coupling member 24B which extends through the mounting section 22B of the bracket 22, and an opposite end of the post or coupling member 24B is coupled to a locking member 24C. The handle 24A, post 24B and locking member 24C are operatively coupled to one another, and the handle 24A is illustratively actuatable relative to the locking member 24C between a release position illustrated by example in FIG. 1 and a locked position illustrated by example in FIG. 2 such that the handle 24A is movable toward and away from the outer face of the mounting section 22B of the bracket 22. With the handle 24A in the release position, the locking member 24 is illustratively received within the channel 12A, e.g., via an open end of the rail 12, and the locking member 24 is slid along the rail 12 to a desired location. Once at the desired location, the handle 24A is actuated, e.g., manually moved, to the locked position in which the post 24B draws the locking member 24C into engagement with the inner faces of the flanges 12B, 12C to secure the mounting assembly 24, and thus the bracket 22 and the retractor 20, to the rail 12. In some embodiments, either or both the outer surfaces and/or the opposing ends of the flanges 12B, 12C may define notches, channels or other conventional structures spaced apart axially along the rail 12, and the opposing surface of the mounting section 22B of the bracket 22 contacting the flanges 12B, 12C may define one or more complementary structures configured to engage one or more such notches, channels or other conventional structures to further secure the cargo restraint module 18 to the rail 12 and to prevent or at least impede or resist axial movement of the module 18 along the rail 12 after the handle 24A of the mounting assembly 24 is actuated to the locked position.

In some alternate embodiments, the locking member 24C may be sized and configured, e.g., as a rectangle, oval or other similar shape, such that, in one orientation of the locking member 24C, the locking member 24C is sized and configured to extend through the opening 12D of the rail 12 and into the channel 12A, and in another orientation, e.g., 90 degrees rotated, the locking member 24C engages the inner surfaces of the flanges 12B, 12C and is blocked by the flanges 12B, 12C from exiting the channel 24A. In such embodiments, the release position of the handle 24A is that which allows the locking member 24C to enter the channel 12A via the opening 12D, and the locked position of the handle 24A is that which causes the locking member 24C to engage the inner surfaces of the flanges 12B, 12C to secure the mounting assembly 24 to the rail 12, and the handle 24A is illustratively movable, e.g., rotatable, between such release and locked positions.

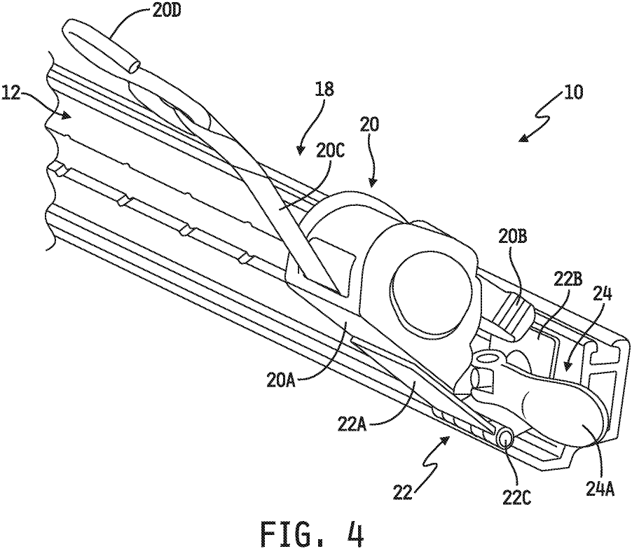

As illustrated by example in FIG. 4, the retractor mounting section 22A is rotatable via the hinge 22C relative to the truck bed mounting section 22B to selectively orient the retractor 20 to any desired angle and/or position between or relative to the sections 22A, 22B in order to facilitate securement by the cargo restraint module 18 of cargo to the truck bed 16. In some embodiments in which the hinge 22C is freely rotatable, one or more locating and/or coupling structures may be provided to locate and/or couple the bracket 22 of the cargo restraint module 18 to the side 16A of the truck bed 16 when the module 18 is not in use. For example, as most clearly depicted in FIG. 1, magnetic discs 26A and 26B may be affixed to the exposed face of the retractor mounting section 22A of the bracket 22 and the engagement structure 20D respectively. With the retractor mounting section 22A rotated via the hinge 22C relative to the truck bed mounting section 22B to an example storage position in which the retractor mounting section 22A and the engagement structure 20D contact the side 16A of the truck bed 16, the magnetic discs 26A, 26B magnetically secure the retractor mounting section 22A and the engagement structure 20D of the cargo restraint module 18 to the side 16A of the truck bed 16 and thereby prevent the module 18 from moving relative to the truck bed 16 during transport. Those skilled in the art will recognize other structures and/or techniques for securing the module 18 in a storage position relative to the truck bed 16 to prevent movement thereof during transport, and it will be understood that any such other structures and/or techniques are intended to fall within the scope of this disclosure.

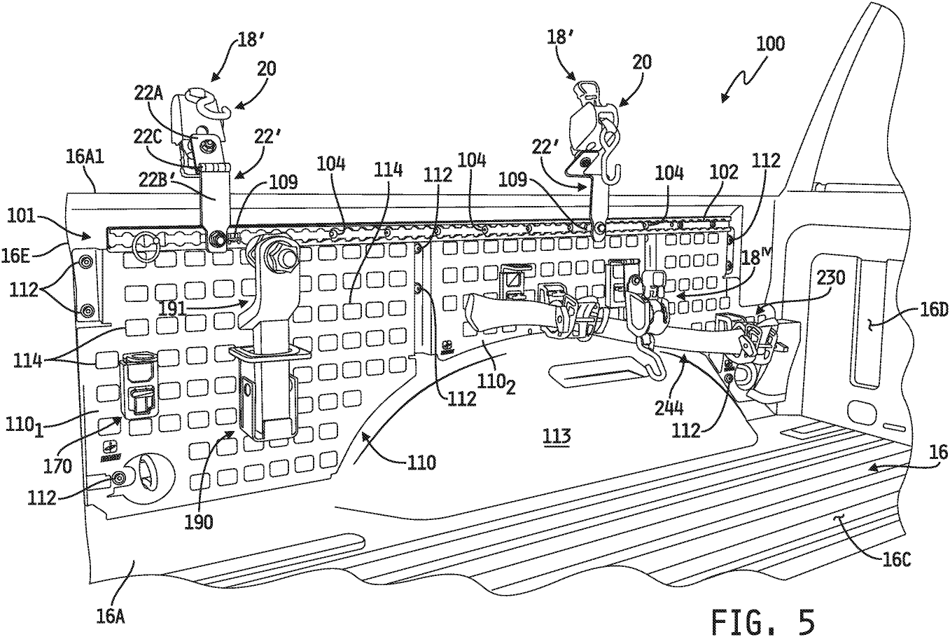

Referring now to FIG. 5, another embodiment is shown of a cargo securement system 100 including a cargo restraint module support structure 101 in the form of another embodiment of a support rail 102 and an embodiment of a lattice structure 110 each secured to and along at least one inner side 16A of a truck bed 16. In the illustrated embodiment, the support rail 102 is an elongated rail affixed to the inner wall of one side 16A of the truck bed 16 adjacent to, and parallel with, the top edge or lip 16A1 of the truck bed 16 via a number of conventional fixation members 104. In alternate embodiments, the support rail 102 may be affixed to the side wall 16A at any location between the bottom 16C of the truck bed and the top 16A1 of the side wall 16A and/or with any orientation relative to the bottom 16C of the truck bed 16 or relative to the top 16A1 of the side wall 16A. In the illustrated embodiment, the length of the example support rail 102 is sized to span the length of the truck bed side wall 16A between the front 16D of the truck bed 16 and the rear 16E of the truck bed 16, although in alternate embodiments the support rail 102 may be shorter than the length of the side wall 16A and may be mounted at any position along the side wall 16A, e.g., centrally, offset to one side or the other, etc. In any case, although only one support rail 102 is shown mounted to the side wall 16A, the support rail 102 may, in alternate embodiments, take the form of two or more support rails 102 mounted end-to-end to the side wall 16A or each with any orientation relative to the side wall 16. It will be understood that while a support rail 102 is illustrated in FIG. 5 as being mounted only to one side 16A of the truck bed 16, one or more support rails 102 may additionally be mounted to the opposite side 16B of the truck bed 16 (see, e.g., FIG. 13), to the front 16D of the truck bed 16, e.g., behind the cab area in embodiments in which the motor vehicle is a pickup truck or other vehicle having a cab area in front of the bed 16, and/or to the rear 16E of the truck bed, e.g., to a tailgate 17 in embodiments in which the motor vehicle includes a tailgate.

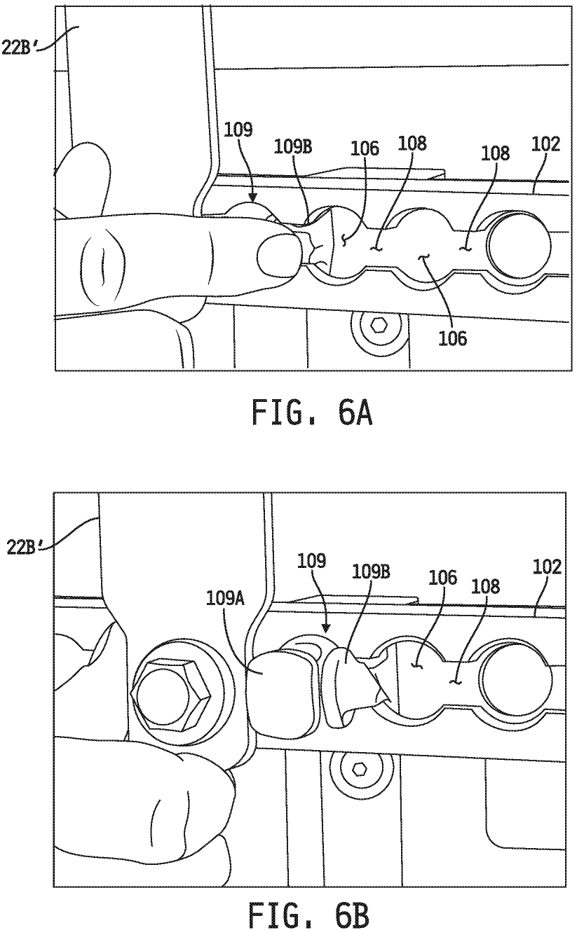

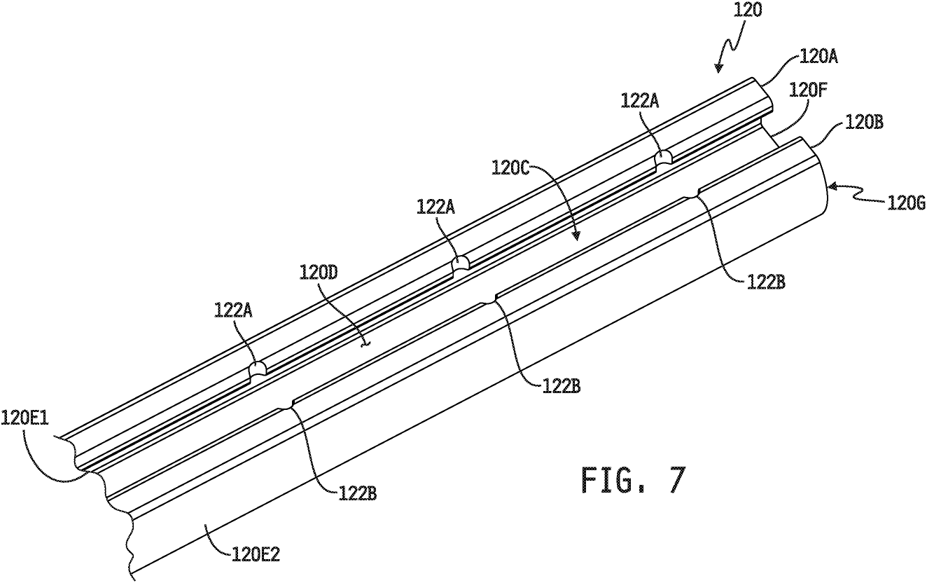

As illustrated most clearly in FIGS. 6A and 6B, the support rail 102 is illustratively a conventional rigid structure defining a plurality of wells or pockets 106 spaced longitudinally therealong in an outwardly-facing surface thereof, each illustratively separated from and joined to adjacent ones of the wells or pockets 106 by a corresponding one of a plurality of channels 108. In this embodiment, another embodiment of a cargo restraint module 18′ is shown detachably mountable to the support rail 102, wherein the module 18′ includes a bracket 22′ similar to the bracket 22 illustrated in FIGS. 1-2, a retractor 20 attached to the bracket 22′ and a mounting anchor assembly 109 also attached to the bracket 22′. In some embodiments, the retractor 20 is the same retractor 20 illustrated in FIGS. 1-2 and 4 and described above, although in other embodiments the retractor 20 may be any type of web retractor, ratcheting or otherwise. The bracket 22′ is identical to the bracket 22 in that it includes the retractor mounting section 22A to which the retractor 20 is mounted, i.e., attached, and a hinge 22C operatively coupled to the retractor mounting section 22A. In this embodiment, the hinge 22C is also operatively coupled to a substantially planar truck bed mounting section 22B′ to which the mounting anchor 109 is attached. In some alternate embodiments, the mounting sections 22A, 22B′ of the bracket 22′ may have any shape(s), i.e., with one or more curved sections, with one or more bends, etc. As also described above, the hinge 22C may, in some embodiments, be replaced with any conventional structure for moving the retractor mounting section 22A relative to the truck bed mounting section 22B′.

As illustrated by example in FIGS. 6A and 6B, the mounting anchor assembly 109 illustratively includes a mounting anchor 109A coupled to a manually-actuatable locking/release member 109B for selectively securing the bracket 22′ to a desired position along the rail 102. With the anchor 109A inserted into, and locked relative to, one of the wells or pockets 106, the locking/release member 109B may be actuated, as illustrated in FIG. 6A, to release the anchor 109A so that the anchor assembly 109, and thus the module 18′, may be moved axially along the rail 102 to another well or pocket 106. With the locking/release member 109B released, as illustrated by example in FIG. 6B, the member 109B locks the anchor 109A in and to the respective well or pocket 106 and thus to a desired position along the support rail 102. In one embodiment, the locking/release member 109B is illustratively spring biased so that it automatically locks when the anchor 109A is suitably located in the respective well or pocket 106, although in other embodiments the locking/release may instead be manually lockable. In the embodiment illustrated in FIG. 5, two such cargo restraint modules 18′ are shown releasably mounted to the support rail 102 via respective brackets 22′.

Referring again to FIG. 5, the lattice structure 110 is illustratively an elongated structure secured to the inner wall of one side 16A of the truck bed 16 via a number of conventional fixation members 112. In the illustrated embodiment, the lattice structure 110 extends between the front 16D and the rear 16E of the truck bed 16, and a top end of the lattice structure 110 is trapped between the support rail 102 and the inner wall of the side 16A of the truck bed 16 such that the support rail 102 and the top end of the lattice structure 110 are together affixed to the inner wall of the side 16A of the truck bed 16 adjacent to, and parallel with, the top edge or lip 16A1 of the truck bed 16. In alternate embodiments, the top end of the lattice structure 110 may be affixed to the inner wall of the side 16A of the truck bed 16 separately from the support rail 102. In any case, a bottom end of the lattice structure 110 extends toward the bottom or floor 16C of the truck bed 16, and in the illustrated embodiment the bottom end of the lattice structure 110 is configured to accommodate, and extend adjacent to, an upper surface of a wheel well 113.

The lattice structure 110 is illustratively a generally flat, plate-like structure, e.g., made of a suitable steel or similar material, defining a periodic matrix of openings 114 therethrough each sized to accommodate mounting of a cargo restraint module or module component to the lattice structure 110. In the illustrated embodiment, the lattice structure 110 is formed of two lattice structure units 110₁, 110₂ positioned end-to-end along the side 16A of the truck bed 16. In alternate embodiments, the lattice structure 110 may include more lattice structure units mounted end-to-end to the side wall 16A and/or each with any orientation relative to the side wall 16, or may be provided in the form of a single, unitary lattice structure.

In some alternate embodiments, the lattice structure 110 may be secured to the side wall 16A at any location between the bottom 16C of the truck bed and the top 16A1 of the side wall 16A and/or with any orientation relative to the bottom 16C of the truck bed 16 or relative to the top 16A1 of the side wall 16A. In some alternate embodiments, the lattice structure 110 may be shorter than the length of the side wall 16A and may be mounted at any position along the side wall 16A, e.g., centrally, offset to one side or the other, etc. In any case, it will be understood that while a lattice structure 110 is illustrated in FIG. 5 as being mounted only to one side 16A of the truck bed 16, one or more lattice structures 110 may alternatively or additionally be mounted to the opposite side 16B of the truck bed 16 (see, e.g., FIG. 13), to the front 16D of the truck bed 16, e.g., behind the cab area in embodiments in which the motor vehicle is a pickup truck or other vehicle having a cab area in front of the bed 16, and/or to the rear 16E of the truck bed, e.g., to a tailgate 17 in embodiments in which the motor vehicle includes a tailgate. Moreover, whereas the cargo restraint module support structure 101 is illustrated in FIG. 5 as including both of the support rail 102 and the lattice structure 110, alternate embodiments of the cargo securement system 100 may include only the support rail 102 or only the lattice structure 110 mounted to the inner wall of the side 16A, side 16B, front 16D and/or rear 16E of the truck bed 16. In some alternate embodiments, the inner wall of the side 16A, side 16B, front 16D and/or rear 16E of the truck bed 16 may define the lattice structure 110 itself. In such embodiments, one or more liners, e.g., flexible, semi-rigid or rigid, may be provided to cover the lattice structure(s) 110 when storing and/or hauling loose material(s) in the truck bed 16 such as sand, gravel, dirt, or the like. Such one or more liners may illustratively be non-porous or semi-porous, and in any case will be configured to retain the loose material(s) in the truck bed 16 when suitably positioned within the truck bed 16 over the lattice structure(s) 110 or between the inner and outer walls of the side 16A, side 16B, front 16D and/or rear 16E of the truck bed 16.

Referring now to FIG. 7, an alternate embodiment of a support rail 120 is shown which may be used with or in place of the support rail 12 illustrated in FIGS. 1-4, and/or which may be used with or in place of the support rail 102 illustrated in FIG. 5-6B. In the illustrated embodiment, the support rail 120 is illustratively a C-shaped structure having opposing flanges 120A, 120B defining an opening 120D therebetween that defines an opening to a channel 120C bound by inner surfaces of the flanges 120A, 120B, inner surfaces of side walls 120E1, 120E2 extending downwardly from the flanges 120A, 120B and an inner surface of a bottom wall 120F joining the side walls 120E1, 120E2. In the illustrated embodiment, the flanges 120A, 120B, the side walls 120E1, 120E2 and the bottom wall 120F are all of unitary construction, although in alternate embodiments one or more of the flanges and/or walls may be separate a separate component mounted to one or more other components to form the rail 120. In one embodiment, the rail 120 is illustratively formed of a suitable metal such as aluminum, although in alternate embodiments the rail 120 may be or include other conventional materials including, for example, but not limited to steel, thermoplastic, a thermoset material or other conventional material(s). In any case, the support rail 120 illustratively has at least one open end 120G for receiving a mounting assembly of a cargo restraint module within the channel 120C.

In the illustrated embodiment, opposing notches, channels or other conventional structures 122A, 122B are defined in and through the opposed ends of the flanges 120A, 120B respectively, and a plurality of opposed pairs of such notches 122A, 122B are spaced apart axially along the rail 120. The notches 122A, 122B are illustratively sized and configured to engage complementarily configured detents or other engagement structures defined on or mounted to a cargo restraint module 18 for the purpose of securing the cargo restraint module 18 to the support rail 120 and to prevent or at least impede or resist axial movement of the cargo restraint module 18 along the support rail 120 after the cargo restraint module 120 is secured thereto. It will be understood that while the notches 122A, 122B are depicted in FIG. 7 as having half-circle shapes, the notches 122A, 122B in alternate embodiments may have shapes other than half-circle. Axial spacing between the notch pairs 122A, 122B is illustratively equidistant along the support rail 120, although in alternate embodiments some portions or all of the rail 120 may define uneven spacing between the notch pairs 122A, 122B. For example, which should not be considered limiting, one or more portions of the support rail 120 in which it is more likely than other portions that a cargo restraint module 18 may be mounted thereto may include a higher density of notch pairs 122A, 122B, i.e., a plurality of more closely-spaced notch pairs 122A, 122B.

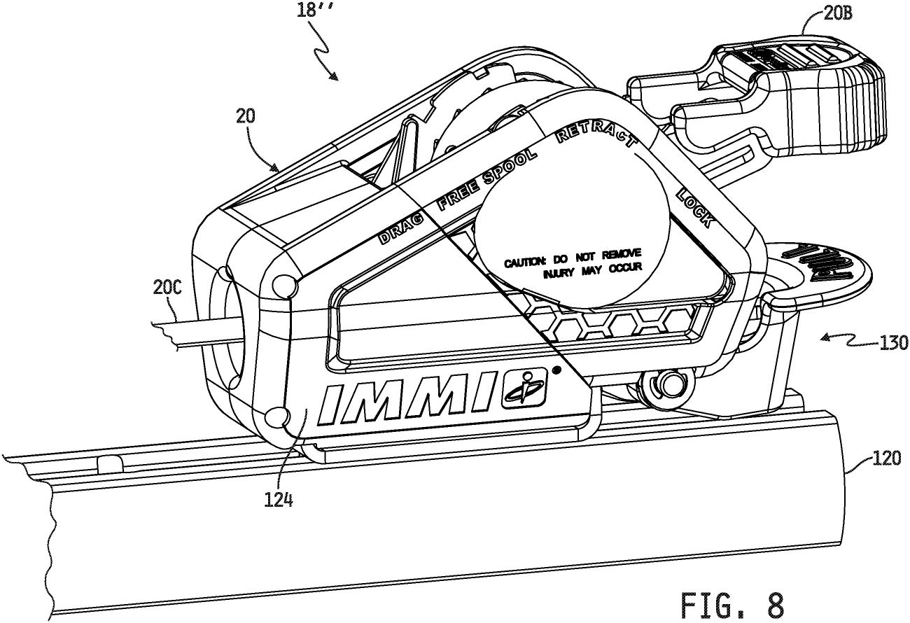

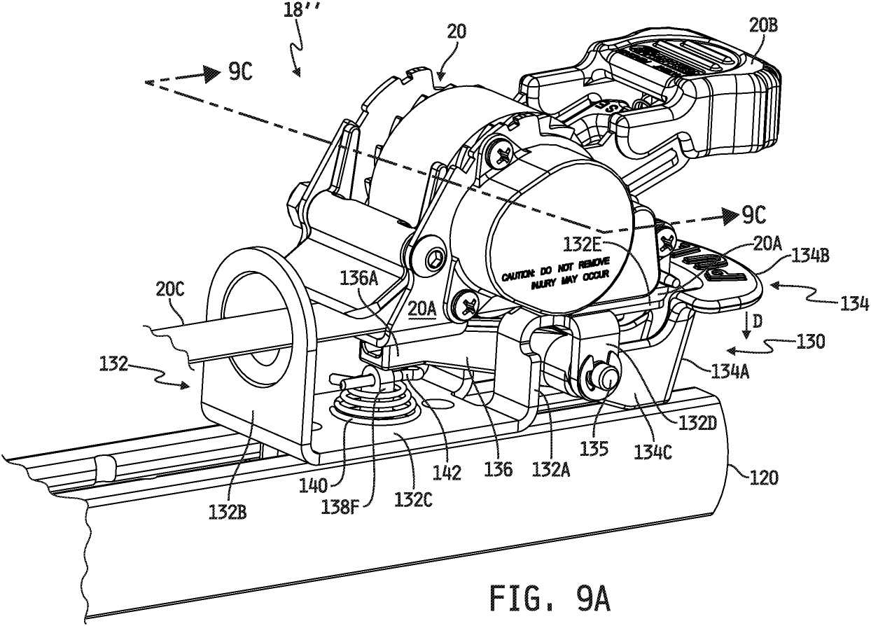

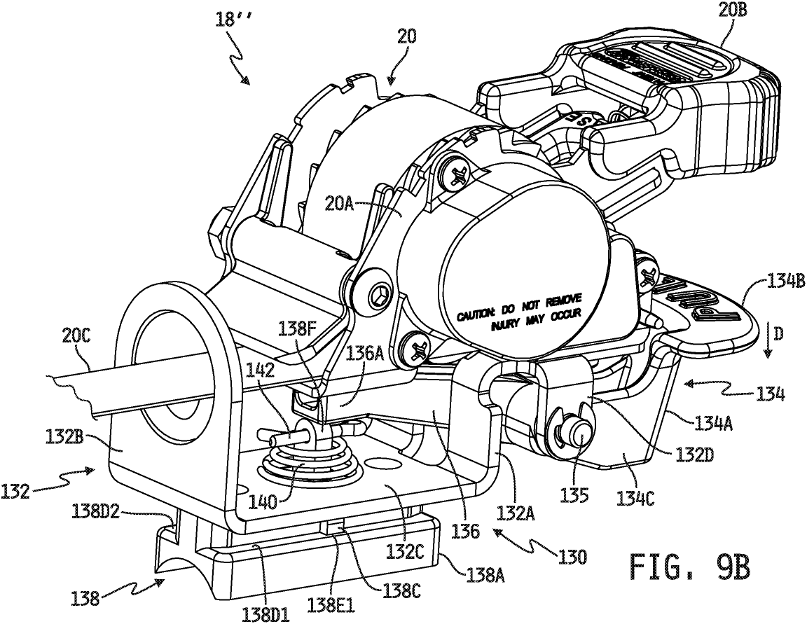

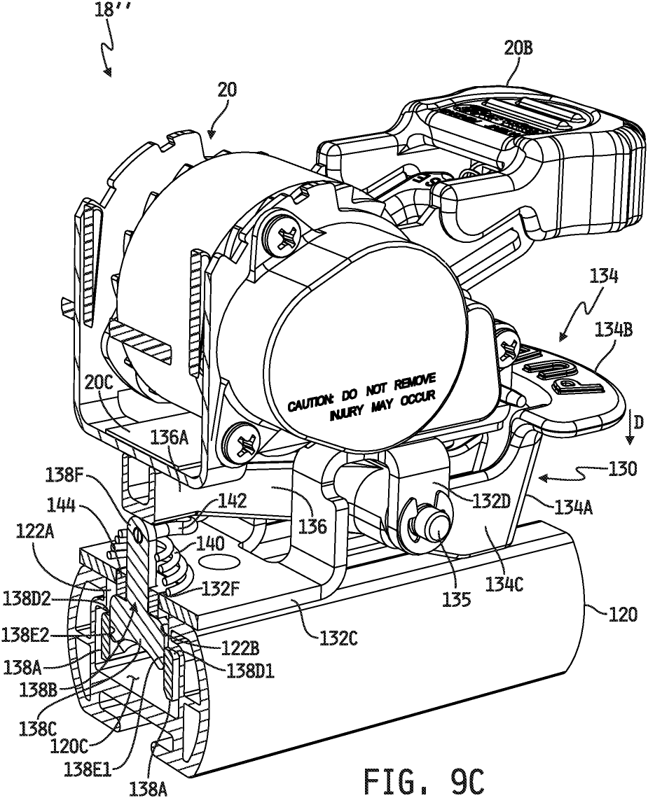

Referring now to FIG. 8-10C, another embodiment of a cargo restraint module 18″ is shown detachably mountable to the support rail 120 of FIG. 7, wherein the module 18″ includes a retractor 20 attached and secured to a mounting assembly 130 that is configured to detachably, i.e., releasably, mount the restraint module 18″ to the support rail 120. In some embodiments, the retractor 20 is the same retractor 20 illustrated in FIGS. 1-2 and 4 and described above, although in other embodiments the retractor 20 may be any type of web retractor, ratcheting or otherwise. With the cover 124 of the retractor 20 depicted in FIG. 8 removed, details of the mounting assembly 130 are seen in FIGS. 9A and 9B. In the embodiment shown in FIGS. 9A and 9B, the mounting assembly 130 illustratively includes a frame 132 mounted and secured to the frame 20A of the retractor 20, a locking and release handle 134 movably mounted to the frame 132 and a rail engagement member 138 movably mounted to the frame 132 and operatively coupled to the locking and release handle 134. The frame 132 illustratively includes two spaced-apart walls 132A, 132B joined by a bottom wall 132C, wherein the wall 132B is configured, e.g., with an opening, to allow the web 20C of the retractor 20 to pass therethrough. The frame 132 further defines a retractor mounting wall 132E extending rearwardly of the wall 132A, and the frame 20A of the retractor 20 is attached and secured to the retractor mounting wall 132E. A pair of handle mounting tabs or ears 134D extend downwardly from the retractor mounting wall 132E on either side thereof (only one such tab or ear 134C shown in FIGS. 9A and 9B). In the illustrated embodiment, planes defined by the respective walls 132A, 132B are parallel with one another, planes defined by the respective walls 132C and 132E are parallel with one another and perpendicular to the planes defined by the walls 132A, 132B, and the mounting tabs or ears 132D extend generally perpendicularly away from the retractor mounting wall 132E adjacent to the wall 132A, although it should be understood that this arrangement of walls 132A-132E represents only one example such arrangement and should not be considered limiting, it being understood that other arrangements of the walls 132A-132E are contemplated by this disclosure.

The locking and release handle 134 illustratively includes a handle body 134A and a handle grip 134B extending rearwardly from a top end of the handle body 134A. The handle grip 134B is illustratively positioned proximate to the handle 20B of the retractor 20 such that the distance between the handle grip 134B and the handle 20B is less than a span of a human hand so that the handle grip 134B and the handle 20B can be simultaneously gripped by a human hand. The handle 20B can, for example, be contacted by a palm or heel of a human hand while one or more fingers of the hand pull upwardly on the handle grip 134B to actuate the handle 134.

A pair of frame engaging arms 134C extend forwardly from either side of the handle body 134A (only one such arm 134C shown in FIGS. 9A and 9B), and each define openings therethough which align with openings defined through the mounting tabs or ears 132D of the frame 132. A rail engagement actuating member 136 extends forwardly from the frame engaging arms 134C, and defines an opening therethrough aligned with the openings defined through the frame engaging arms 134C and the mounting tabs or ears 132D. An elongated pin extends through the aligned openings of the mounting tabs or ears 132D, the frame engaging arms 134C of the locking and release handle 134 and the rail engagement actuating member 136 such that the handle body 134A, the handle grip 134B, the frame engaging arms 134C and the rail engagement actuating member 136 are all movable, e.g., pivotable, together about the pin 135. In one embodiment, the handle body 134A, the handle grip 134B, the frame engaging arms 134C and the rail engagement actuating member 136 are all of unitary construction, although in alternate embodiments one or more of these components may be separate from the others and connectable or attachable to one another to form the locking and release handle 134.

As best shown in FIG. 9B, the rail engagement member 138 includes an elongated rail engagement body 138A sized and configured to be received within the channel 120C of the support rail 120 depicted in FIG. 7 (e.g., received into the channel 120C at an end 120F of the rail 120, and a detent member 138B movably mounted to the body 138A. The rail engagement body 138A illustratively defines a pair of shoulders 138D1, 138D2 illustratively having planar surfaces configured to slide along the inner surfaces of the flanges 120A, 120B of the support rail 120 in a release state of the rail engagement member 138. A detent body 138C is slidingly received within the rail engagement body 138A, and a detent post 138F extends upwardly away from the detent body 138C, through an opening 132F defined through the bottom wall 132C of the frame 132 and into engagement with a post-engaging end 136A of the rail engagement actuating member 136. A collar or washer 144 is illustratively disposed in the opening 132F, and the detent post 138F illustratively extends through a central opening of the collar or washer 144. The shoulders 138D1, 138D2 each define an opening 138E1, 138E2 respectively therethrough (see also FIGS. 9B and 9C), and in a locked state of the rail engagement member 138 the detent body 138C extends upwardly through the openings 138E1, 138E2. A biasing member 140, e.g., a coil spring, is illustratively positioned about the detent post 138F, and a retaining member 142, e.g., a pin or other such component, is passed through an opening adjacent to an end of the detent post 138F such that the biasing member 140 is disposed between the inner surface of the bottom wall 132C of the frame 132 and the retaining member 142.

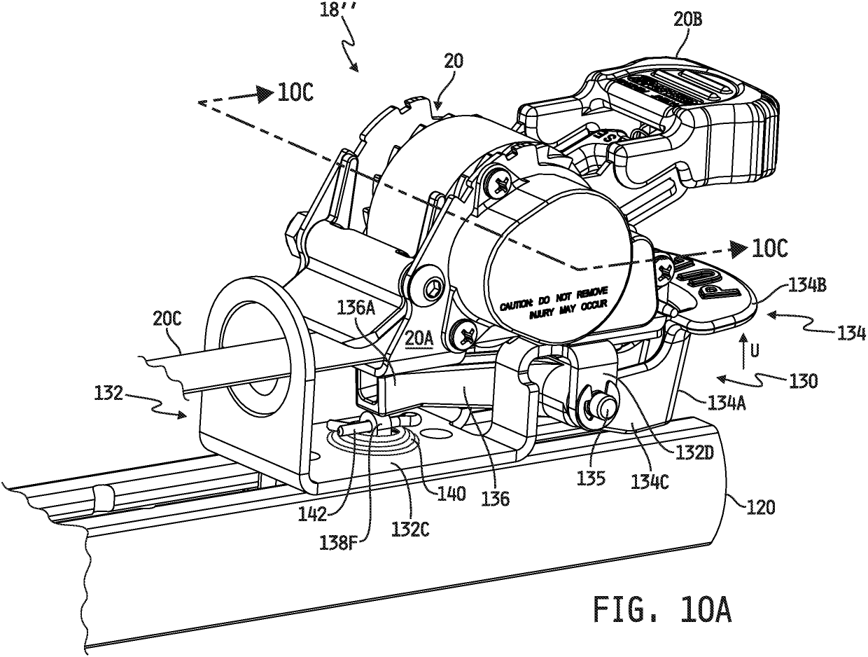

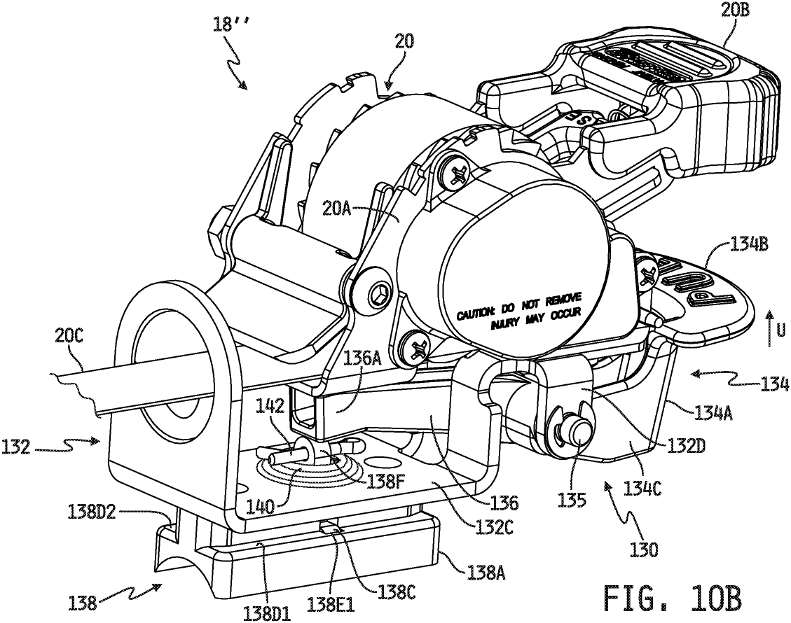

The rail engagement member 138 is actuatable via manual actuation of the locking and release handle 134 between a locked state illustrated by example in FIGS. 9A-9C and a release state illustrated by example in FIGS. 10A-10C. In the locked state of the rail engagement member 138 illustrated in FIGS. 9A-9C, the biasing member 140 acts on the retaining member 142 to bias the handle 134 downwardly in the direction D into a locking position, and to also bias the detent post 138B upwardly through the bottom wall 132C of the frame 132 such that the detent body 138C extends through the openings 138E1, 138E2 defined through the shoulders 132D1, 132D2 of the rail engagement body 138A. When the cargo restraint module 18″ is mounted to the support rail 120 with the rail engagement body 138A received within the channel 120C of the support rail 120, and the cargo restraint module 18″ is positioned relative to the support rail 120 such that the detent body 132C extending through the shoulders 132D1, 132D2 on opposite sides of the rail engagement body 138A aligns with one of the plurality of opposed pairs of channels 122A, 122B defined along the support rail 120, the detent body 132 is received within the channels 122A, 122B to secure the rail engagement member 138, and thus the cargo restraint module 18″, to the support rail 120, i.e., such that the cargo restraint module 18″ is prevented from moving axially along the support rail 120.

To move the rail engagement member 138 from the locked state just described to the release state so that the cargo restraint module 18″ can be moved axially along the support rail 120 to a different position, an upward force that is greater than the biasing force of the biasing member 140, is applied to the handle grip 134B, i.e., in the direction U, as illustrated by example in FIG. 10B. This causes the arms 134C and the rail engagement actuating member 136 to rotate about the pin 135 such that the post-engaging end 136A of the rail engagement actuating member 136 acts on the detent post 138F to force the detent body 136C downwardly through the openings 138E1, 138E2 defined through the shoulders 138D1, 138D2 of the rail engagement body 138A as the biasing member 140 is compressed. As best shown in FIG. 10C, this causes the detent body 136C move out of the channels 122A, 122B and below the inner surfaces of the flanges 120A, 120B of the support rail 120 so that the cargo restraint module 18″ is then free to be moved axially along the support rail 120. When suitably positioned such that the detent body 136C is again aligned with another pair of channels 122A, 122B, the handle grip 134B is released which causes the detent body 136C to move into the channels 122A, 122B to secure the cargo restraint module 18″ to the support rail 120 in this position. If the detent body 136C is not aligned with the channels 122A, 122B, the cargo restraint module 18″ can be moved, with the handle grip 134B released, relative to the support rail 120 until such alignment occurs in which case the bias of the biasing member 140 forces the detent body 136C into the channels 122A, 122B.

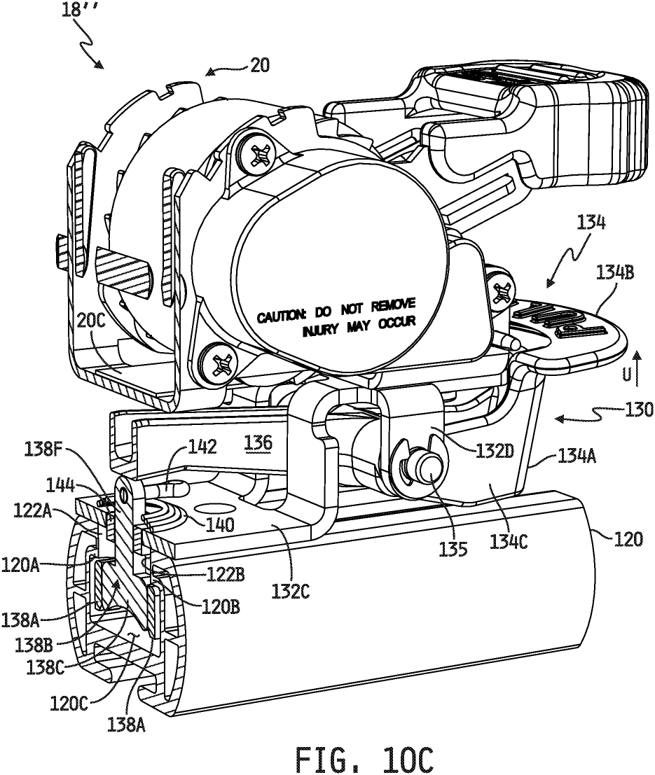

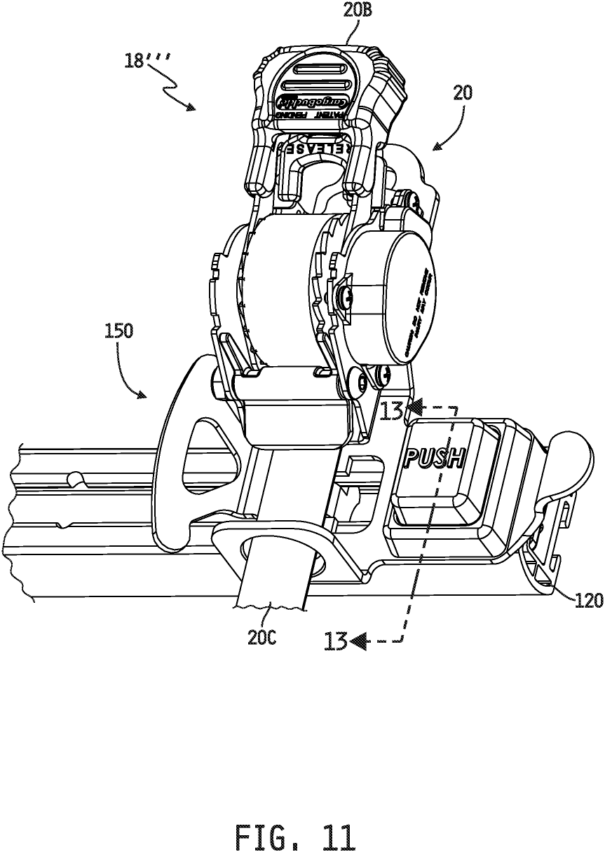

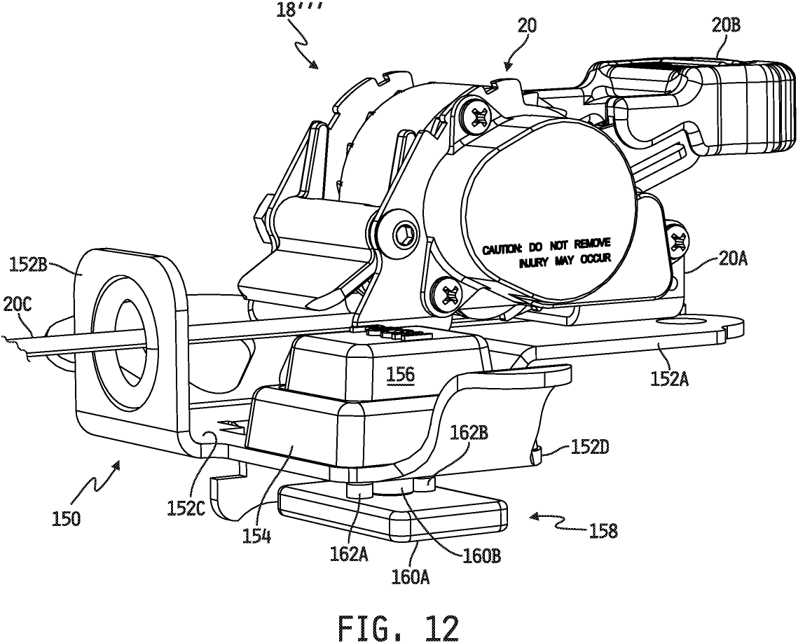

Referring now to FIGS. 11-14, yet another embodiment of a cargo restraint module 18‴ is shown detachably mountable to the support rail 120 of FIG. 7, wherein the module 18‴ includes a retractor 20 attached and secured to a mounting assembly 150 that is configured to detachably, i.e., releasably, mount the restraint module 18‴ to the support rail 120. In some embodiments, the retractor 20 is the same retractor 20 illustrated in FIGS. 1-2 and 4 and described above, although in other embodiments the retractor 20 may be any type of web retractor, ratcheting or otherwise. The mounting assembly 150 illustratively includes a frame 152 mounted and secured to the frame 20A of the retractor 20, a locking and release button 156 movably mounted to the frame 152 and a rail engagement member 158 movably mounted to the frame 152 and operatively coupled to the locking and release button 156. The frame 152 illustratively includes a retractor mounting wall 152A spaced apart from a side wall 152B and joined by a bottom wall 152C. The frame 20A of the retractor 20 is attached and secured to the retractor mounting wall 152A, and the side wall 152B opposite the retractor 20 is configured, e.g., with an opening, to allow the web 20C of the retractor 20 to pass therethrough. Another bottom wall 152D, or an extension of the bottom wall 152C, extends laterally away from the bottom wall 152C, and the locking and release button 156 is operatively mounted to the bottom wall 152D.

A locking and release button housing 154 is positioned on the top surface of the bottom wall 152D, and the housing 154 defines an opening 154A therethrough. A lip or rim 154B is defined between the opening 154A and side walls of the housing 154 as best shown in FIG. 14. The locking and release button 156 defines a flange or collar 156A extending outwardly away from a bottom surface 156B thereof, and the button 156 is received within the housing 154 such that a top surface 156C of the button 156 extends outwardly above the opening 154A of the housing 154. A rail engagement body 160A of the rail engagement member 158 is illustratively coupled to one end of an elongated post 160B, and an opposite end of the post 160B is coupled to the bottom 156B of the locking and release button 156. A pair of projections 162A, 162B, e.g., pins, extend upwardly from the rail engagement body 160A on either side of the post 160B, and a biasing member 164, e.g., a coil spring, is positioned between the top surface of the bottom wall 152D and the bottom surface 156B of the locking and release button 156. The biasing member 164 exerts an upward force on the locking and release button 156 to normally bias the button 156 to and through the opening 154A defined through the button housing 154.

The rail engagement member 158 is actuatable via manual actuation of the locking and release button 156 between a locked state illustrated by example in FIGS. 11-13 and a release state illustrated by example in FIG. 14. It should be noted that in the embodiment illustrated in FIGS. 11-14, the retractor 20 is mounted laterally relative to the support rail 120, i.e., such that the axial direction of the web 20C paid out of and taken up by the retractor 20 is generally perpendicular to the longitudinal axis of the support rail 120, whereas in the embodiment illustrated in FIG. 8-10C, the retractor 20 is mounted axially relative to the support rail 120, i.e., such that the axial direction of the web 20C being paid out of and taken up by the retractor 20 is generally parallel with, indeed co-linear with, the longitudinal axis of the support rail 120.

In the locked state of the rail engagement member 158 illustrated in FIGS. 11-13, the biasing member 164 acts against the bottom wall 152D of the frame 152 to bias the locking and release button 156 upwardly until the flange or collar 156A extending away from the bottom 156B of the button 156 engages the ring 154B defined about the periphery of the opening 154A defined through the button housing 154 as best illustrated in FIG. 13. When the cargo restraint module 18‴ is mounted to the support rail 120 with the rail engagement body 158A received within the channel 120C of the support rail 120, and the cargo restraint module 18‴ is positioned relative to the support rail 120 such that the projections 162A, 162B align with one of the plurality of opposed pairs of channels 122A, 122B defined along the support rail 120, the projections 162A, 162B are received within the channels 122A, 122B to secure the rail engagement member 158, and thus the cargo restraint module 18‴, to the support rail 120, i.e., such that the cargo restraint module 18‴ is prevented from moving axially along the support rail 120.

To move the rail engagement member 158 from the locked state just described to the release state so that the cargo restraint module 18‴ can be moved axially along the support rail 120 to a different position, an downward force that is greater than the biasing force of the biasing member 164, is applied to the top 156C of the locking and release button 156. As illustrated by example in FIG. 14, this drives the rail engagement body 160A into the channel 120C of the support rail 120 which, in turn, moves the projections 162A, 162B out of the channels 122A, 122B and below the inner surfaces of the flanges 120A, 120B of the support rail 120 so that the cargo restraint module 18‴ is then free to be moved axially along the support rail 120. When suitably positioned such that the projections 162A, 162B are again aligned with another pair of channels 122A, 122B, the locking and release button 156 is released which causes the biasing member 164 acting on the button 156 to move the projections 162A, 162B into the channels 122A, 122B to secure the cargo restraint module 18‴ to the support rail 120 in this position. If the projections 162A, 162B are not aligned with the channels 122A, 122B, the cargo restraint module 18‴ can be moved, with the button 156 released, relative to the support rail 120 until such alignment occurs in which case the bias of the biasing member 164 forces the projections 162A, 162B into the channels 122A, 122B.

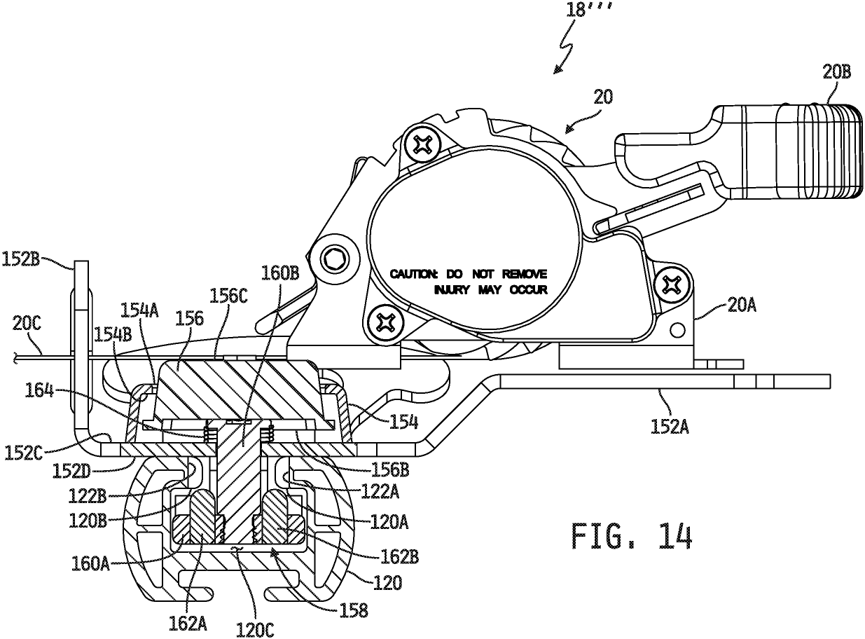

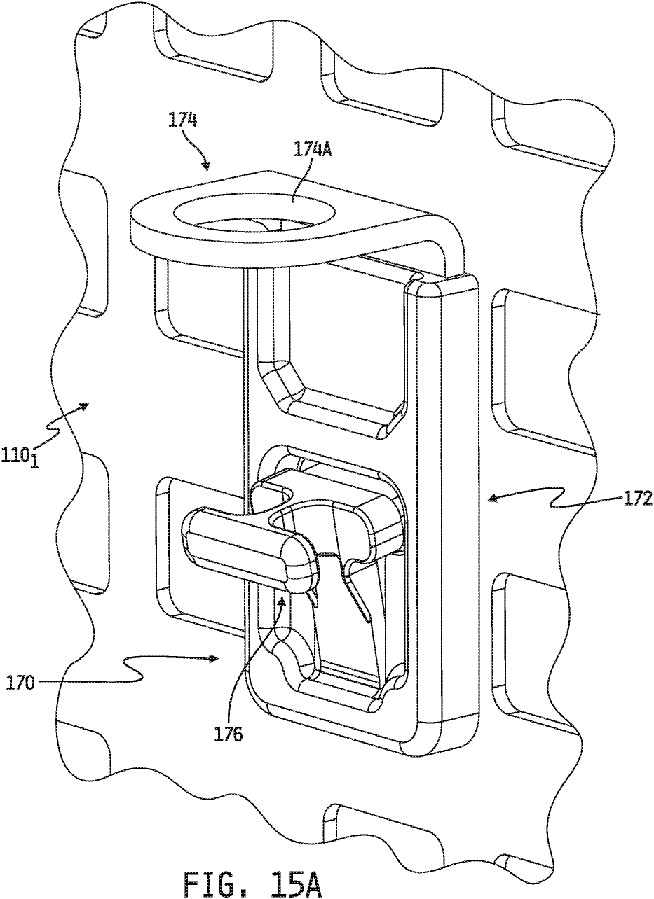

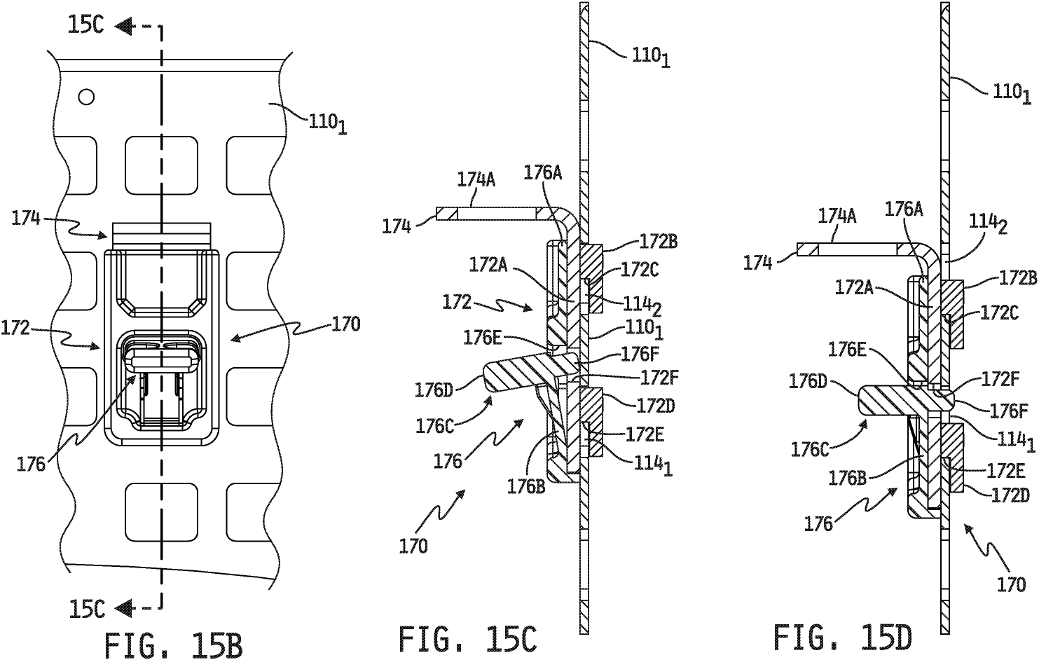

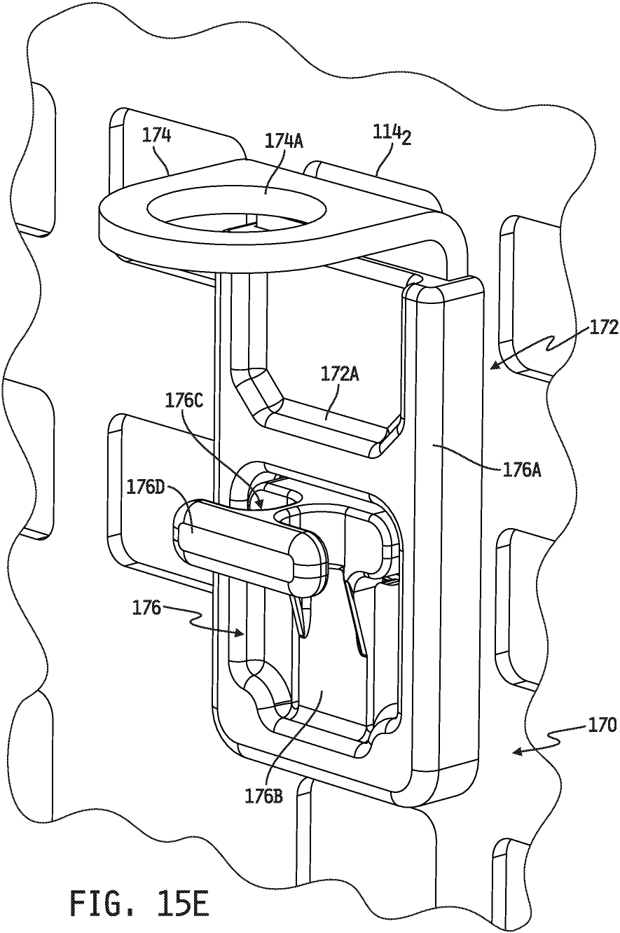

As illustrated in FIG. 5, a number of different example cargo restraint modules are shown mounted and secured to the lattice structure 110. Some such modules may include or define or more structures for engaging the engagement structure(s) 20D of one or more cargo restraint modules 18, 18′, 18‴ mounted to a support rail 12, 102 and/or to the lattice structure 110 itself, and other such modules may include or define one or more structures configured to secure one or more specific cargo structures to the lattice structure 110, between a support rail 12, 102, 120 and the lattice structure 110 and/or between the lattice structure 110 and another support structure of or mounted to the truck bed 16. Several different cargo restraint module embodiments configured to be mounted and secured to the lattice structure 110 are illustrated by example in FIGS. 15A-24G and will be described in detail below. It will be understood, however, that such cargo restraint module embodiments are provided only by way of example and are not intended to be limiting in any way. Other cargo restraint modules mountable and securable to the lattice structure 110 will occur to those skilled in the art, and all such other cargo restraint modules are intended to fall within the scope of this disclosure.

Referring now to FIGS. 5 and 15A-15E, an embodiment of a cargo restraint module 170 is shown mounted to the lattice structure 110₁ via two of the openings 114₁ and 114₂ defined therethrough. In the illustrated embodiment, the cargo restraint module 170 is provided in the form of a mounting bracket 172 coupled to a connection structure 174 configured to couple to an engagement structure(s) 20D of one or more cargo restraint modules 18, 18′, 18‴ and/or to any releasably engageable connector such as a hook, clip or other suitable structure. The mounting bracket 172 illustratively includes main body 172A from which generally L-shaped brackets 172B and 172D rearwardly extend. Relative to the mounted orientation of the module 170 on the lattice structure 110₁, the bracket 172B is disposed vertically above the bracket 172D, and a vertical slot or channel 172C, 172E is defined between the main body 172A and the brackets 172B, 172D respectively with open ends of the slots 172C, 172E generally facing downwardly. The brackets 172B, 172D are illustratively sized at least slightly smaller than the openings 114 defined through the lattice structure 110₁, and the slots 172C 172E are illustratively sized to have the same or slightly larger width than the thickness of the lattice structure 110₁. The mounting bracket 172 can thus be mounted to the lattice structure 110₁, as illustrated in FIGS. 15C and 15D, by passing the brackets 172B, 172D through the openings 114₂, 114₁ respectively (see, e.g., FIG. 15C), and then passing the slots 172C, 172E over the body portions of the lattice structure 110₁ located below the respective openings 114₂, 114₁ by pressing downwardly on the mounting bracket 172 (see, e.g., FIG. 15D). The connection structure 174 illustratively extends upwardly from the top of the main body 172 and outwardly away from the lattice structure 110₁, and in the illustrated embodiment the connection structure 174 defines an opening 174A therethrough such that a releasably engageable connector, e.g., an engagement structure(s) 20D of one or more cargo restraint modules 18, 18′, 18‴, can be releasably secured to the connection structure 174. In the illustrated embodiment, the mounting bracket 172 and the connection structure 174 are of unitary construction, although in alternate embodiments the mounting bracket 172 and the connection structure 174 may be separate structures coupled together after fabrication thereof, and/or the mounting bracket 172 may be formed of two or more separate structures coupled together to form the bracket 172.

The cargo restraint module 170 further illustratively includes a securement assembly 176 mounted to the main body 172A of the mounting bracket 172 and configured to selectively secure the mounting bracket 172 to the lattice structure 110₁. The securement assembly 176 illustratively includes a cover or housing 176A affixed to a front surface of the main body 172A of the mounting bracket 172, a mounting portion 176B coupled to the housing 176A and a securement portion 176C coupled to, and disposed vertically above, the mounting portion 176B. In the illustrated embodiment, the housing 176A, the mounting portion 176B and the securement portion 176C are of uniform construction, although in alternate embodiments the mounting portion 176B may be separate from the housing 176A and may be movably, e.g., pivotably, mounted to the housing 176A at or near a lower end thereof to the main body 172A of the bracket 172, e.g., via a pin or other suitable structure. In one embodiment, the housing, 176A, mounting portion 176B and securement portion 176C are made of a conventional thermoplastic, thermoset or other polymer, although in other embodiments the housing 176A, mounting portion 176B and/or securement portion 176C may be made of one or more other suitable materials. In any case, the mounting portion 176B is pivotable or otherwise movable relative to the housing 176A toward and away from the lattice structure 110₁ such that the securement portion 176C is likewise pivotable or otherwise movable toward and away from the lattice structure 110₁.

A handle 176D extends forwardly away from the securement portion 176C to facilitate gripping of the securement portion 176C and moving of the securement portion 176C, via movement of the mounting portion 176B relative to the housing 176A, between engaged and disengaged positions of the securement portion 176C relative to the main body 172A of the bracket 172 and relative to the lattice structure 110₁. The main body 172A of the bracket 172 defines an opening 172F therethough and the housing 176A likewise defines an opening 176E therethrough which is aligned and juxtaposed with the opening 172F. A lattice insertion portion 176F extends rearwardly away from the securement portion 176C, and the lattice insertion portion 176F is sized and configured to extend through the openings 172F, 176E and into the opening 114₁ of the lattice structure 110₁ in the engaged position of the securement portion 176C.

As briefly described above, the securement portion 176C is movable, via movement of the mounting portion 176B relative to the housing 176A, between engaged and disengaged positions of the securement portion 176C relative to the main body 172A of the bracket 172 and relative to the lattice structure 110₁. Referring to FIGS. 15A and 15C, for example, the cargo restraint module 170 is mounted to the lattice structure 110₁ by inserting the brackets 172B, 172D into the openings 114₂, 114₁ respectively defined through the lattice structure 110₁. As the brackets 172B, 172D enter the openings 114₂, 114₁ respectively, the solid body portion of the lattice structure 110₁ defined between the openings 114₂, 114₁ contacts the insertion portion 176F of the securement portion 176C and forces securement portion away from the opening 176E to the disengaged position of the securement portion 176C as the mounting portion 176B pivots or otherwise moves relative to the housing 176A as best shown in FIG. 15C. The mounting portion 176B is illustratively biased toward the engaged position of the securement portion 176C, such that in the disengaged position of the securement portion 176C the bias is applied by the mounting portion 176B in the direction of the engaged position of the securement portion 176C. From the position of the cargo restraint module 170 illustrated in FIGS. 15A and 15C, the brackets 172B, 172D are forced downwardly such that the slots 172C, 172E pass over the body portions of the lattice structure 110₁ located below the respective openings 114₂, 114₁. As illustrated in FIG. 15D, as the slots 172C, 172E pass over the body portions of the lattice structure 110₁ located below the respective openings 114₂, 114₁, the juxtaposed openings 176E, 172F defined through the housing 176A and the main body 172A of the bracket 172 respectively come into alignment with the opening 114₁ of the lattice structure 110₁, and the bias of the mounting portion 176B moves the securement portion from the disengaged position to the engaged position by forcing the insertion portion 176F of the securement portion 176C through the juxtaposed openings 176E, 172F and through the opening 114₁ of the lattice structure 110₁. In the engaged position of the securement portion 176C, the insertion portion 176F prevents movement of the cargo restraint module 170 relative to the lattice structure 110₁ to a position in which the brackets 172B, 172D would align with the respective openings 114₂, 114₁ defined through the lattice structure 110₁, thus securing the cargo restraint module 170 to the lattice structure 110₁.

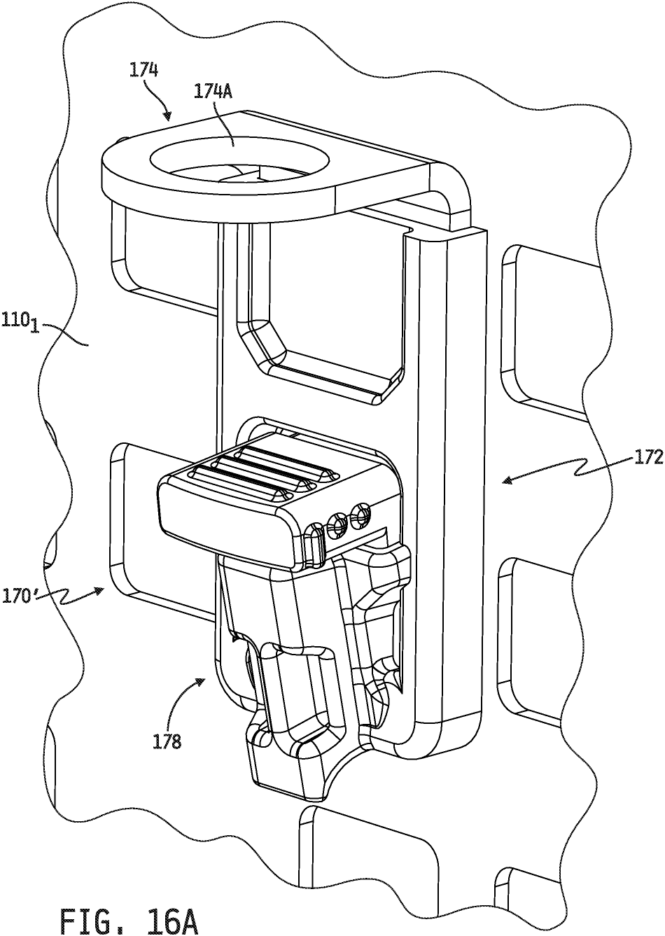

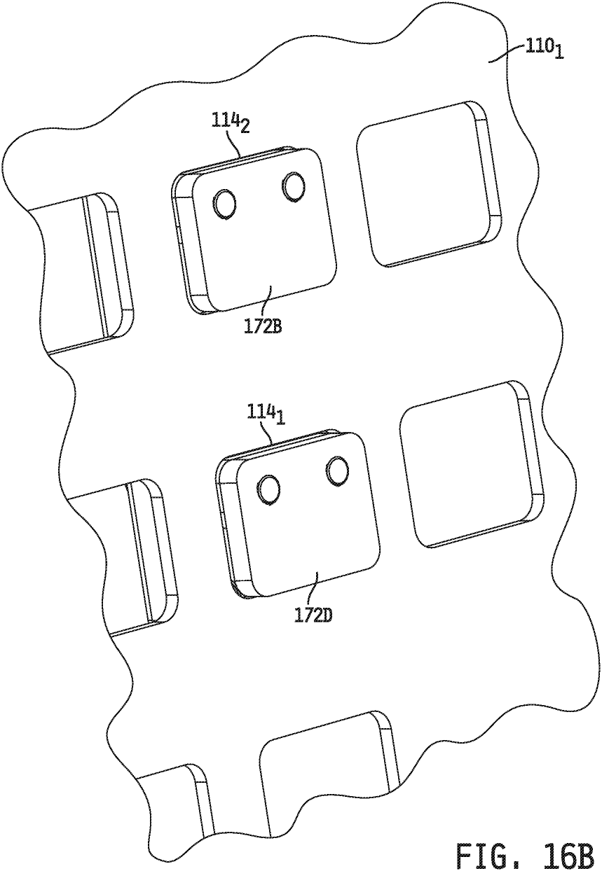

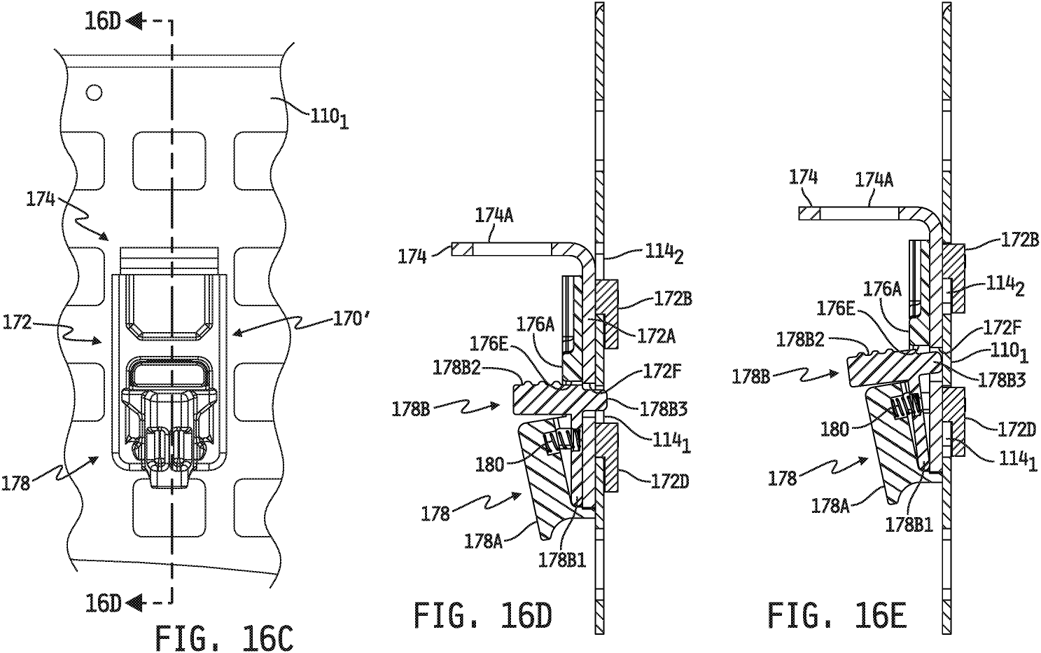

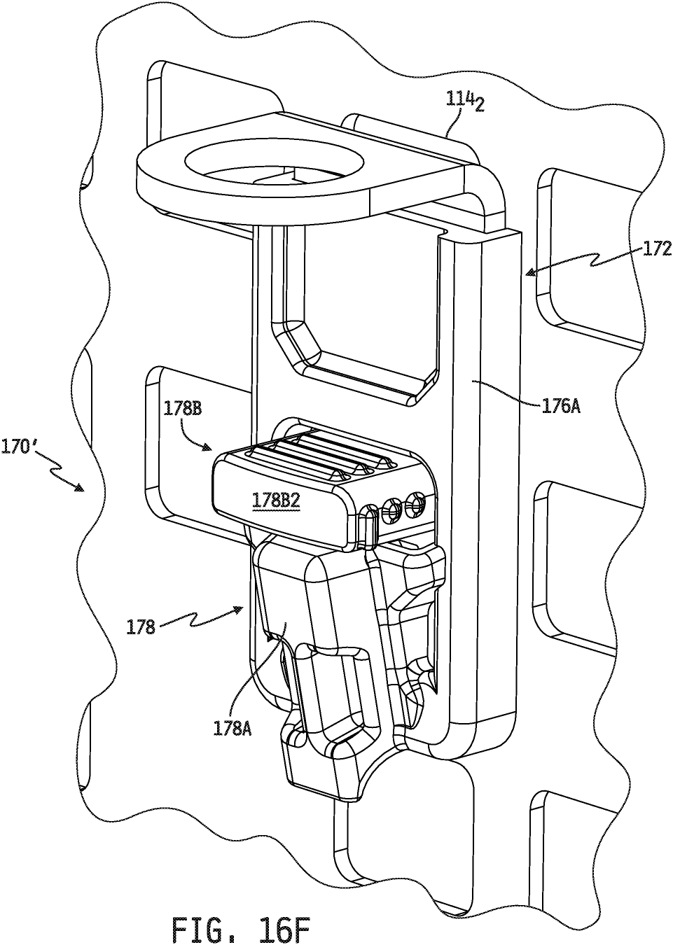

Referring now to FIGS. 16A-16G, an alternate embodiment 170′ of the cargo restraint module 170 depicted in FIGS. 15A-15E is shown mounted to the lattice structure 110₁ via two of the openings 114₁ and 114₂ defined therethrough. The cargo restraint module 170′ is generally operable in the same manner as the restraint module 170 and is identical in many respects to the cargo restraint module 170, and in such respects like numbers are used to identify like components. The cargo restraint module 170′ illustratively differs from the cargo restraint module 170 in that the securement assembly 176 is replaced with another embodiment of a securement assembly 178. In the illustrated embodiment, the securement assembly 178 includes the cover or housing 176A affixed to a front surface of the main body 172A of the mounting bracket 172, a mounting portion 178A coupled to the housing 176A and a securement portion 178B movably, e.g., pivotably, coupled to the mounting portion 178A. A biasing member 180, e.g., a coil spring, is coupled to and between the mounting portion 178A and the handle base 178B1 of the securement portion 178B. The biasing member 180 illustratively biases the securement portion 178B toward and to the engagement position of the securement portion thereof illustrated by example in FIGS. 16D, 16F and 16G. Illustratively, the housing 176A, the mounting portion 178A and the securement portion 178B are made of a conventional thermoplastic, thermoset or other polymer, although in other embodiments the housing 176A, mounting portion 178A and/or securement portion 178B may be made of one or more other suitable materials.

A handle 178B2 is defined at one end of the handle base 178B1 and extends forwardly away from the securement portion 178B to facilitate gripping of the securement portion 178B and moving of the securement portion 179B, relative to the mounting portion 178A, between engaged and disengaged positions of the securement portion 178B relative to the main body 172A of the bracket 172 and relative to the lattice structure 110₁. The main body 172A of the bracket 172 defines an opening 172F therethough and the housing 176A likewise defines an opening 176E therethrough which is aligned and juxtaposed with the opening 172F as described above. A lattice insertion portion 178B3 extends rearwardly away from the securement portion 178B, and the lattice insertion portion 17B3 is sized and configured to extend through the openings 172F, 176E and into the opening 114₁ of the lattice structure 110₁ in the engaged position of the securement portion 178B.

The securement portion 178B is movable, relative to the mounting portion 178A, between engaged and disengaged positions of the securement portion 178B relative to the main body 172A of the bracket 172 and relative to the lattice structure 110₁. Referring to FIGS. 16A, 16B and 16E, for example, the cargo restraint module 170′ is mounted to the lattice structure 110₁ by inserting the brackets 172B, 172D into the openings 114₂, 114₁ respectively defined through the lattice structure 110₁. It should be noted that the view depicted in FIG. 16B is the same as would be depicted for the cargo restraint module 170 of FIGS. 15A-15E. In any case, as the brackets 172B, 172D enter the openings 114₂, 114₁ respectively, the solid body portion of the lattice structure 110₁ defined between the openings 114₂, 114₁ contacts the insertion portion 178B3 of the securement portion 178B and forces securement portion 178B3 away from the opening 176E to the disengaged position of the securement portion 178B as the securement portion 178B moves, e.g., pivots, toward the mounting portion 178A and compresses the biasing member 180 therebetween as best shown in FIG. 16E. From the position of the cargo restraint module 170′ illustrated in FIGS. 16A, 16B and 16E, the brackets 172B, 172D are forced downwardly such that the slots 172C, 172E pass over the body portions of the lattice structure 110₁ located below the respective openings 114₂, 114₁ as best shown in FIGS. 16E and 16G. It will be noted that the view depicted in FIG. 16G is the same as would be depicted for the cargo restraint module 170 of FIGS. 15A-15E. In any case, as the slots 172C, 172E pass over the body portions of the lattice structure 110₁ located below the respective openings 114₂, 114₁, the juxtaposed openings 176E, 172F defined through the housing 176A and the main body 172A of the bracket 172 respectively come into alignment with the opening 114₁ of the lattice structure 110₁, and the bias of the biasing member 180 moves the securement portion 178B, relative to the mounting portion 178A, from the disengaged position illustrated in FIGS. 16A, 16B and 16E to the engaged position illustrated in FIGS. 16E, 16F and 16G by forcing the insertion portion 17B3 of the securement portion 178B through the juxtaposed openings 176E, 172F and through the opening 114₁ of the lattice structure 110₁. In the engaged position of the securement portion 178B, the insertion portion 178B3 prevents movement of the cargo restraint module 170′ relative to the lattice structure 110₁ to a position in which the brackets 172B, 172D would align with the respective openings 114₂, 114₁ defined through the lattice structure 110₁, thus securing the cargo restraint module 170′ to the lattice structure 110₁.

It will be understood that while the openings 114 defined by the lattice structure 110 and the insertions portions of the securement members are illustrated in FIGS. 15A-16G as being generally rounded-corner square or rectangular in shape, the openings 114 and the insertion portions may alternatively have any desired shape, and that any such shape may have any number of linear, piecewise linear and/or curved peripheral sides or sections.

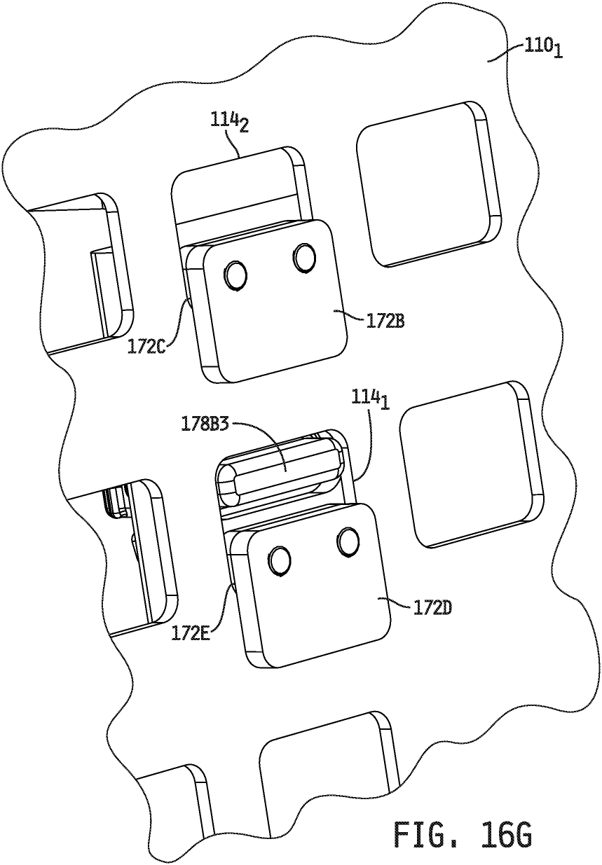

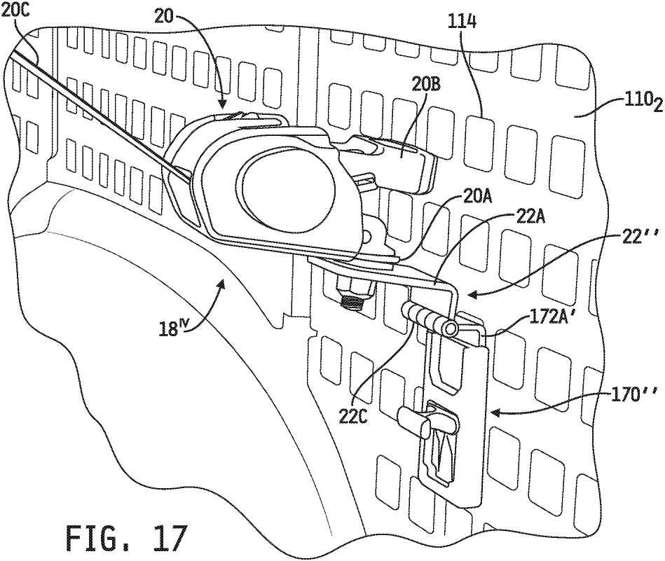

Referring now to FIGS. 5 and 17, another embodiment of a cargo restraint module 18^{IV} is shown mounted to the lattice structure 110₂. The cargo restraint module 18^{IV} is illustratively identical in many respects to the cargo restraint module 18′ illustrated in FIG. 5 and described above, and like numbers are therefore used to identify like components. The cargo restraint module 18^{IV} illustratively differs from the cargo restraint module 18′ in that the bracket 22″ is modified such that the hinge 22C is coupled to and between the retractor mounting section 22A to which the retractor 20 is mounted and a modified main body 172A′ of a correspondingly modified cargo restraint module 170″ configured to be detachably mounted to the lattice structure 110₂. Illustratively, the cargo restraint module 170″ is identical to the cargo restraint module 170 illustrated in FIGS. 15A-15E, and is accordingly detachably mountable to the lattice structure 110₂ via two of the openings 114₁ and 114₂ defined therethrough as described above, except that instead of defining a connection structure 174 at an upper end of the main body of the bracket 172 a portion of the hinge 22C is defined at and by the upper end of the main body 172A′ as illustrated by example in FIG. 17. In alternative embodiments, the cargo restraint module 170” may be configured as a variant of the cargo restraint module 170′ illustrated in FIGS. 16A-16G. In any case, the retractor 20 is illustratively the same retractor 20 illustrated in FIGS. 1-2, 4 and 8-14 and described above, although in other embodiments the retractor 20 may be any type of web retractor, ratcheting or otherwise. In some alternate embodiments, the bracket 22″ may include portions having any shape(s), i.e., with one or more curved sections, with one or more bends, etc. As described above, the hinge 22C may, in some embodiments, be replaced with any conventional structure for moving the retractor mounting section 22A relative to the main body 172A′ of the bracket 172.

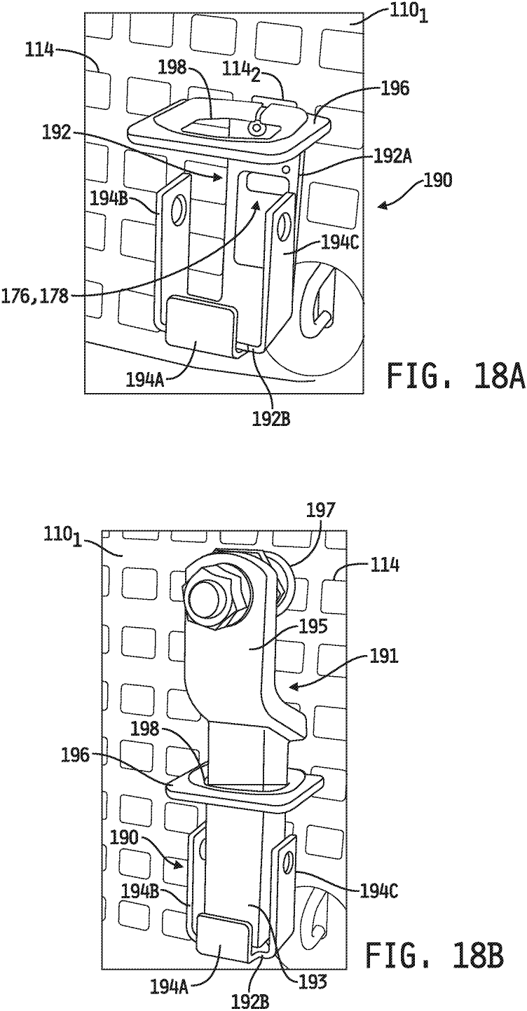

Referring now to FIGS. 5 and 18A and 18B, another embodiment of a cargo restraint module 190 is shown mounted to the lattice structure 110 in the same manner as described above with respect to FIGS. 15A-16G. In the illustrated embodiment, the cargo restraint module 190 is provided in the form of a mounting bracket 192 coupled to a cargo receiving member 196. The mounting bracket 192 illustratively includes a mounting section 192A that is illustratively similar or identical in structure to the main body 172A of the mounting bracket 172 illustrated in FIGS. 15A-16G, and the bracket 192 is therefore illustratively mountable and securable to the lattice structure 110₁ via a securement assembly, e.g., the securement assembly 176 or the securement assembly 178, as described above. The mounting bracket 192 further includes a support section 192B which extends forwardly away from a bottom end of the mounting section 192A, e.g., at approximately a right angle relative to the plane defined by the face of the mounting section 192A, and tabs or ears 194A, 194B, and 194C extend upwardly from the three sides of the support section 192B to form a cargo retaining pocket. The cargo receiving member 196 illustratively extends forwardly away from the top of the bracket 192, e.g., at approximately a right angle relative to the plane defined by the face of the main body 192A, and defines and opening 198 therethrough that is aligned with the pocket defined by the support section 192B and the three tabs or ears 194A, 194B, 194C.

The particular cargo restraint module 190 illustrated in FIG. 18A is illustratively configured to receive and restraining a trailer hitch assembly 191 as illustrated by example in FIG. 18B. Referring to FIG. 18B, the trailer hitch assembly 191 includes a ball mount stem or post 193 having one end configured to be received within a trailer hitch receiver mounted to a motor vehicle, and a ball mount member 195 coupled to an opposite end of the post 193. In the illustrated embodiment, a hitch ball 197 is shown mounted to the ball mount member 195, although it will be understood that the ball 197 need not be included with the trailer hitch assembly 191 in order for the cargo restraint module 190 to receive and restrain the assembly 191. In any case, the trailer hitch assembly 191 is received in the cargo restraint module 190 by inserting the post 193 through the opening 198 and lowering the assembly 191 until the free end of the post 193 is supported by the support section 192B as illustrated in FIG. 18B. When so received, the cargo restraint module 190 is operable to restrain the trailer hitch assembly 191 relative to the lattice structure 110₁ and thus relative to the truck bed 16.

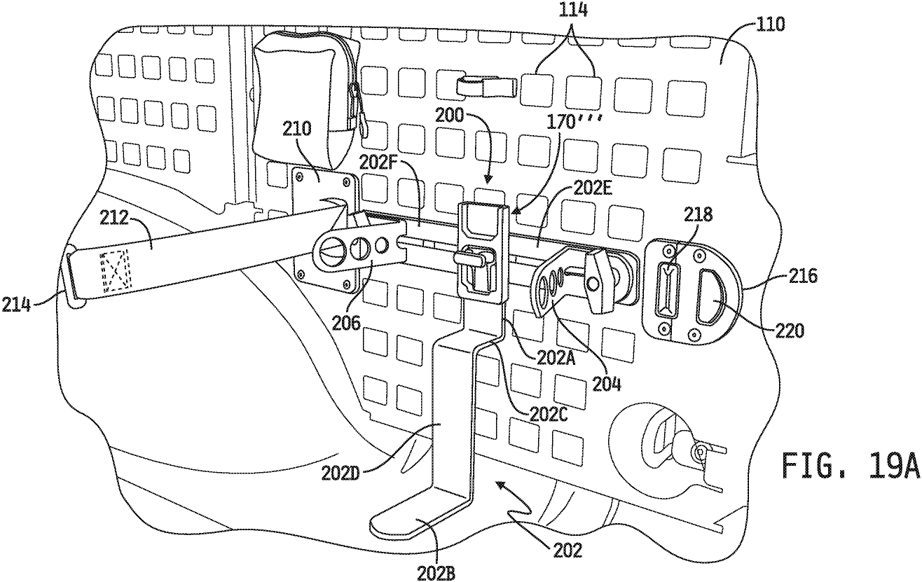

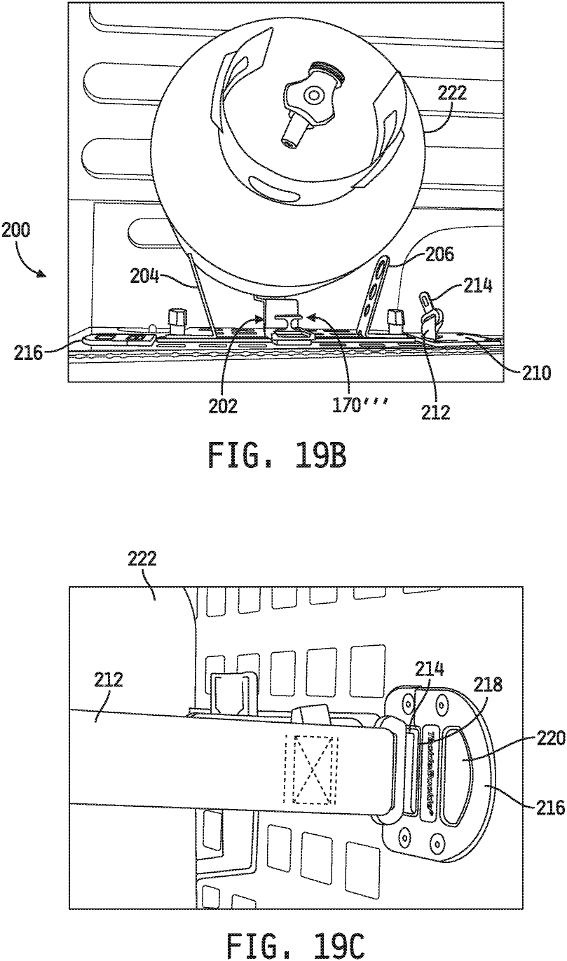

Referring now to FIGS. 19A-19C, yet another embodiment of a cargo restraint module 200 is shown mounted to the lattice structure 110 in the same manner as described above with respect to FIGS. 15A-16G. In the illustrated embodiment, the cargo restraint module 200 includes a mounting bracket 202, a web retractor 210 and a web connecting device 216 all mounted to the lattice structure 110. The mounting bracket 202 illustratively includes a mounting section 202A in the form of a modified main body of a correspondingly modified cargo restraint module 170‴ configured to be detachably mounted to the lattice structure 110. Illustratively, the cargo restraint module 170‴ is identical to the cargo restraint module 170 illustrated in FIGS. 15A-15E, and is accordingly detachably mountable to the lattice structure 110 via two of the openings 114₁ and 114₂ defined therethrough as described above, except that instead of defining a connection structure 174 at an upper end of the main body of the bracket 172 the mounting section 202A extends downwardly away from a lower end of the module 170‴ as illustrated by example in FIG. 17. In alternative embodiments, the cargo restraint module 170‴ may be configured as a variant of the cargo restraint module 170′ illustrated in FIGS. 16A-16G.

The mounting bracket 202 further includes a support section 202B which extends forwardly away from the lattice structure 110, e.g., at approximately a right angle relative to the plane defined by the face of the lattice structure 110, and which is illustratively offset perpendicularly from the plane of the lattice structure 110 by an extension section 202C of the bracket 202 and which is further offset from the mounting section 202A by another extension section 202D. A lateral bracket section 202E extends laterally away from the mounting module 170‴ in one direction, and another lateral bracket section 202F extends laterally away from the mounting module 170‴ in an opposite direction. Cargo retaining legs 204 and 206 extend forwardly away from the lateral bracket sections 202E, 202F respectively on either side of the mounting module 170‴.

The web retractor 210 is coupled to the lattice structure 110 adjacent to the cargo retaining leg 204, and the web connecting device 216 is coupled to the lattice structure 110 adjacent to the cargo retaining leg 206. One end of a conventional web 1212 is coupled to the web retractor 210, and a conventional tongue 214 is coupled to the opposite end of the web 212. The web retractor 210 is conventional in that it is configured to normally draw the web 212 therein, under bias, in a web take-up direction, although the web 212 may be drawn out of the web retractor 210 in a web pay-out direction by pulling on the web 212 in the web pay-out direction with sufficient force to overcome the bias of the web in the web take-up direction. In some embodiments, the web retractor 210 may be a conventional locking retractor. The web connecting device 216 illustratively includes a conventional tongue-engaging member 218 configured to releasably engage the tongue 214, and a conventional tongue release button 220 responsive to actuation thereof to release the tongue 214 from the tongue-engaging member 218.

The particular cargo restraint module 200 illustrated in FIG. 19A is illustratively configured to receive and restrain a cylindrical tank 222, e.g., a gas or propane tank, as illustrated by example in FIG. 19B. In the illustrated embodiment, the module 200 is specifically configured to receive and restrain a conventional 20-pound propane tank 222, although in alternate embodiments the module 200 may be configured or modified to receive and restrain gas tanks of other sizes and/or carrying other gases. Referring to FIG. 19B, the gas tank 222 is received by the cargo restraint module 200 by positioning the gas tank 222 between the two retaining legs 204, 206 and then resting the base of the tank 222 on the support section 202B of the bracket 202. With the tank 222 so positioned, the web 212 is drawn about the tank 222, and the tongue 214 is then inserted into the tongue-engaging member 218 of the web connecting device 216 such that the tongue-engaging member 218 engages the tongue 214 and thus secures the tongue 214 to the web connecting device 216 as illustrated in FIG. 19C. The bias applied to the web 212 by the retractor 210 in the web take-up direction illustratively takes up any web slack, thereby securing the tank 222 to the cargo restraint module 200. When so received, the cargo restraint module 200 is operable to restrain the gas tank 222 relative to the lattice structure 110 and thus relative to the truck bed 16.

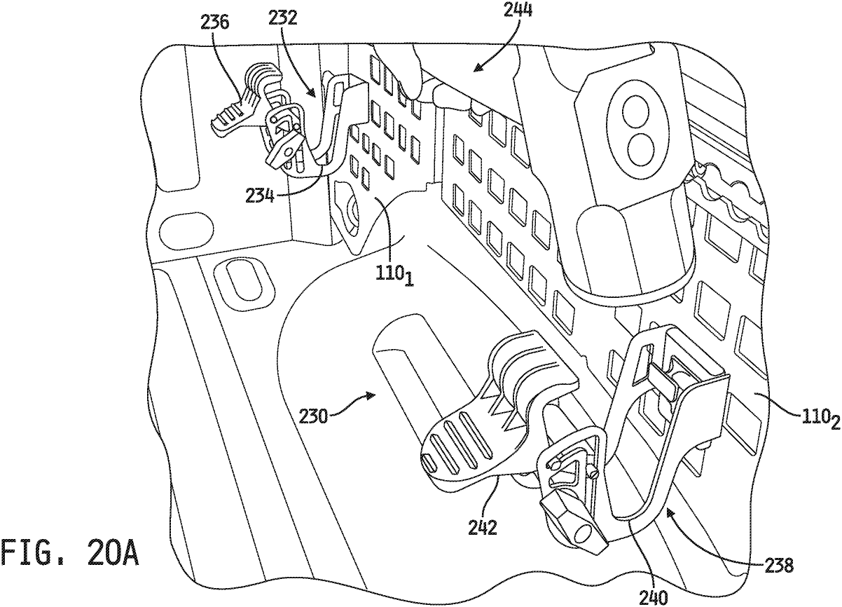

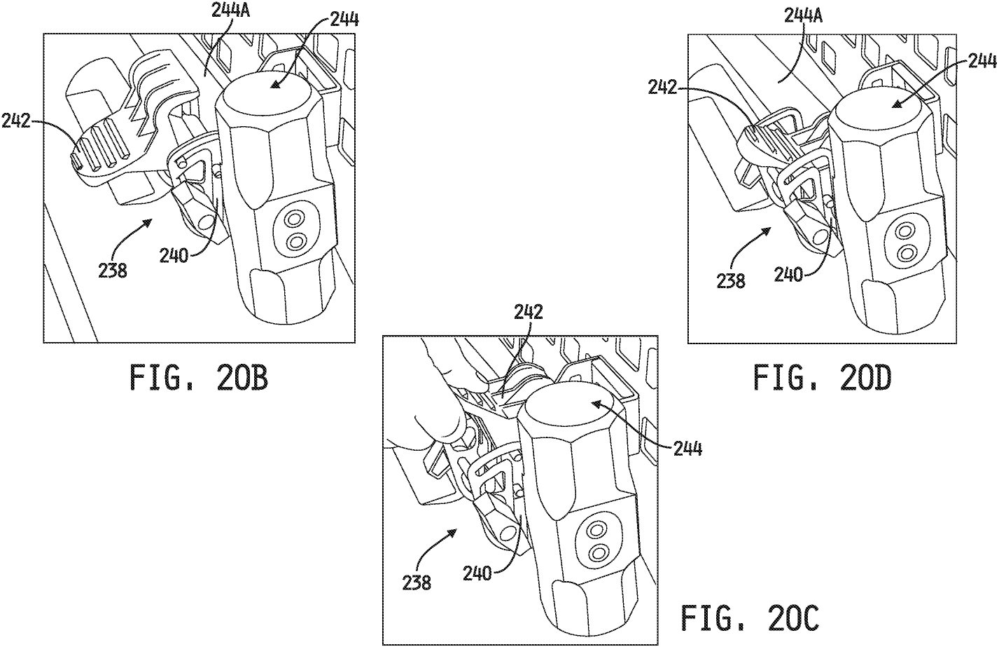

Referring now to FIGS. 5 and 20A-20D, still another embodiment of a cargo restraint module 230 is shown mounted to the lattice structure 110₂ in the same manner as described above with respect to FIGS. 15A-16G. In the illustrated embodiment, the cargo restraint module 230 is provided in the form of two mounting brackets 232 and 238 each mounted to the lattice structure 110₂ in a spaced-apart relationship relative to one another. Illustratively, the mounting brackets 232, 238 may each include a mounting section in the form of a modified main body of a correspondingly modified cargo restraint module 170 or 170″ configured to be detachably mounted to the lattice structure 110 as described above. In any case, in the illustrated embodiment, the mounting brackets 232, 238 are spaced apart from one another by a distance suitable to mount a handle 244A of a handled tool 244 to each and such that the handle 244A of the tool 244 is supported and restrained by and between the brackets 232, 238. In the illustrated embodiment, the brackets 232, 238 are positioned on the lattice structure 110₂ approximately equi-distant from the bottom 16C (or top) of the truck bed so that the handle 244A of the tool 244 is positioned and restrained by the brackets 232, 238 in a substantially horizontal position. It will be understood, however, that the brackets 232, 238 may alternatively be vertically offset from one another so as to position and restrain the handle 244A of the tool 244 in a non-horizontal position. In any case, it will be understood that the tool 244 may be any tool having a handle 244A that is at least partially linear, at least partially curved and/or at least partially piece-wise linear or curved, and that is of sufficient length to mount to and between the two brackets 232, 238. In FIG. 5, the tool 244 is depicted as being provided in the form of a conventional single-bladed axe, and in FIGS. 20A-20C the tool 244 is depicted as being provided in the form of a conventional sledge hammer, although it will be understood that the tool 244 may alternatively be provided in other conventional forms including, but not limited to, other types of hammers, a sickle, a crowbar, or the like, or any other elongated implement such as a baseball bat, hockey stick, lacrosse stick, or the like.

The bracket 232 illustratively includes an arcuate support member 234 and a clamp member 236 movably mounted to the support member 234, and the bracket 238 likewise includes an arcuate support member 240 and a clamp member 242 movably mounted to the support member 240. In the illustrated embodiment, the clamp members 236, 242 are movably mounted to the support members 234, 240 within a pair of opposed tracks defined by the support members such that the clamp members 236, 242 can be moved within the tracks between a tool receiving position which exposes the arcuate support member 234, 240 and allows a portion of the handle 244A of the tool 244 to be received on the arcuate support member 234, 240, as illustrated by example in FIGS. 20A and 20B, and a tool clamping position in which the clamp member 236, 242 is moved over the arcuate support member 234, 240 and the handle 244A of the tool 244, as illustrated by example in FIG. 20C, and then downwardly into contact with the handle 244A of the tool 244 so as to restrain the tool 244 relative to the brackets 232, 238, as illustrated by example in FIG. 20D.

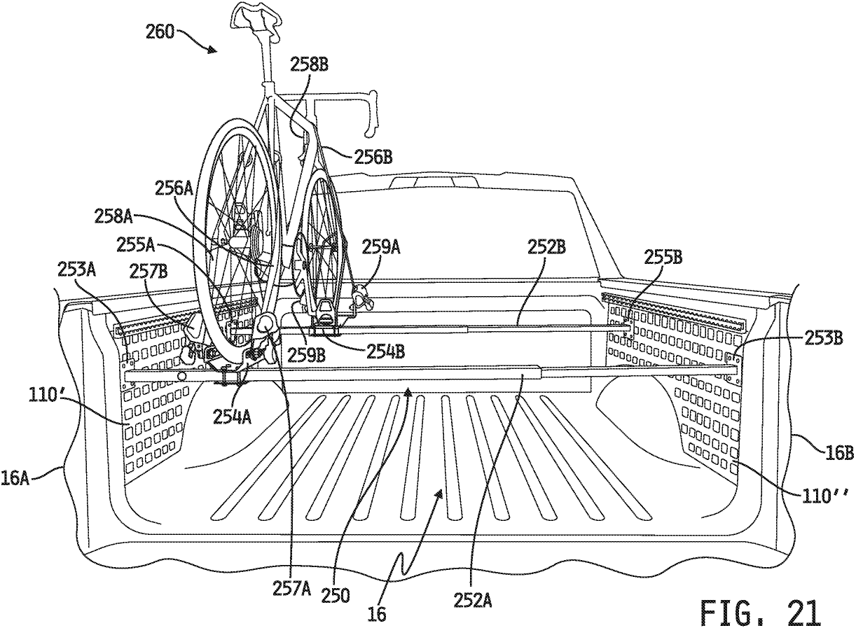

Referring now to FIG. 21, yet a further embodiment of a cargo restraint module 250 is shown mounted to and between opposing lattice structures 110′, 110″ that are mounted and secured to opposite sides 16A, 16B respectively of the truck bed 16. The cargo restraint module 250 is illustratively provided in the form of two elongated support brackets 252A and 252B each mounted to and between the lattice structures 110′, 110″ in a spaced-apart relationship relative to one another with the support bracket 252B forward of the support bracket 252A relative to the truck bed 16. In the illustrated embodiment, a mounting bracket 253A, secures one end of the support bracket 252A to the lattice structure 110′, and another mounting bracket 253B secures the opposite end of the support bracket 252A to the lattice structure 110″. A mounting bracket 255A likewise secures one end of the support bracket 252B to the lattice structure 110′, and another mounting bracket 255B secures the opposite end of the support bracket 252B to the lattice structure 110″. Illustratively, the mounting brackets 253A, 253B, 255A and 255B may each include a mounting section in the form of a modified main body of a correspondingly modified cargo restraint module 170 or 170″ configured to be detachably mounted to the respective lattice structure 110′, 110″ as described above.

A wheel bracket 254A is secured to and supported on the bracket 252A, and another wheel bracket 254B is secured to and supported on the bracket 252B. The wheel brackets 254A, 254B each illustratively define an elongated channel oriented substantially normal to the longitudinal axes of the support brackets 252A, 252B such that the channels of the wheel bracket 254A, 254B are generally parallel with the forward or reverse direction of travel of the pickup truck. In the illustrated embodiment, the mounting brackets 252A, 252B are spaced apart from one another by a distance suitable to position the wheel support brackets 254A, 254B to receive in the channels thereof and support respective spaced apart wheels of a bicycle 260. Although the bicycle 260 is illustrated as having a rear wheel supported on and by the wheel bracket 254A and a front wheel supported on and by the wheel bracket 254B, it will be understood that the position of the bicycle 260 may alternatively be reversed such that the wheel brackets 254A, 254B support the front and rear wheels respectively.

In the illustrated embodiment, a web retractor 255A is mounted to the mounting bracket 252A and/or to the wheel bracket 254A at or near one side of the wheel bracket 254A, and another web retractor 257A is mounted to the mounting bracket 252A and/or to the wheel bracket 254A at or near the opposite side of the wheel bracket 254A. One end of a flexible web 256A is operatively coupled to the web retractor 255A, and one end of another flexible web 258A is operatively coupled to the web retractor 257A. Another web retractor 255B is mounted to the mounting bracket 252B and/or to the wheel bracket 254B at or near one side of the wheel bracket 254B, and yet another web retractor 257B is mounted to the mounting bracket 252B and/or to the wheel bracket 254B at or near the opposite side of the wheel bracket 254B. One end of a flexible web 256B is operatively coupled to the web retractor 255B, and one end of another flexible web 258B is operatively coupled to the web retractor 257B. The opposite ends of the webs 256A, 256B, 258A, 258B are configured to engage a different respective portion of the bicycle 260 to secure the bicycle 260 to the restraint module 260. In one embodiment, for example, hooks or other suitable engagement members may be coupled to the free ends of the webs 256A, 256B, 258A, 258B, and the bicycle 260 may be secured to the restraint module 250 by positioning the wheels of the bicycle 260 on the wheel brackets 254A, 254B, and then securing the free ends of the webs 256A, 256B, 258A, 258B to portions, e.g., frame portions or frame components, of the bicycle 260.

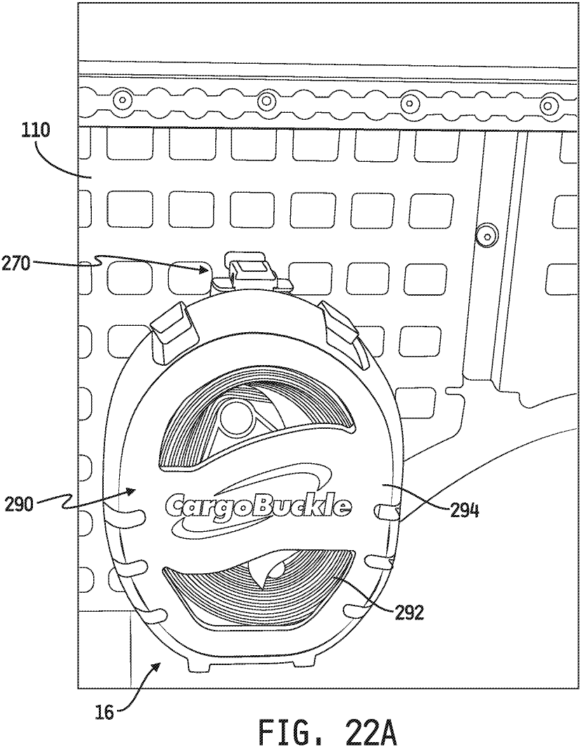

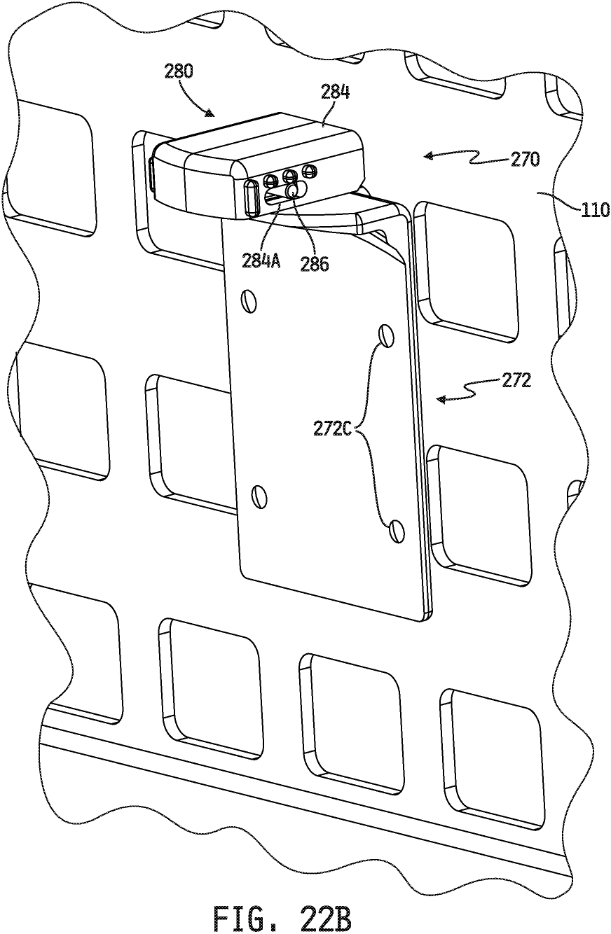

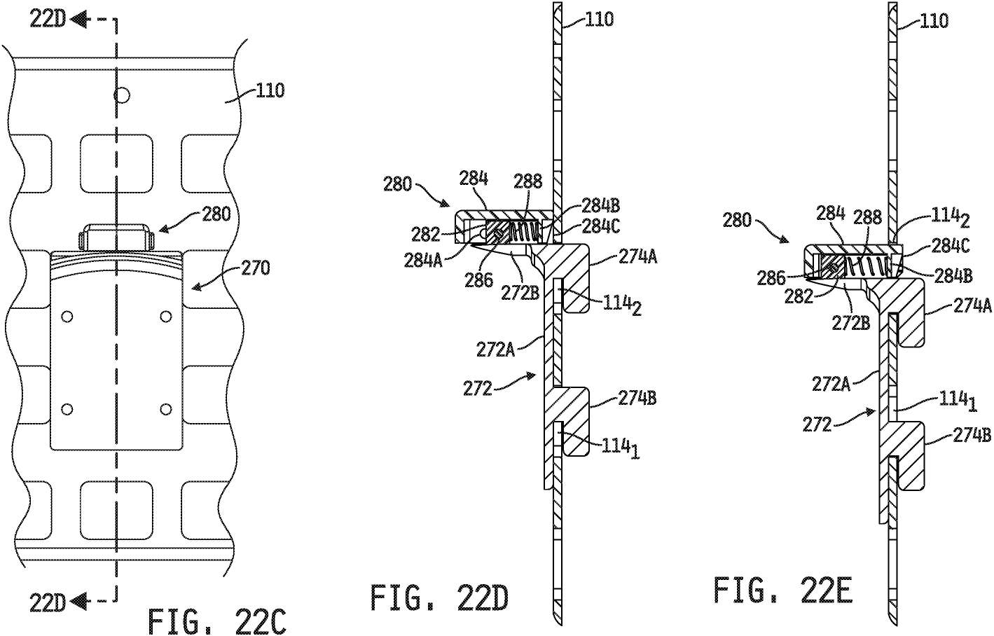

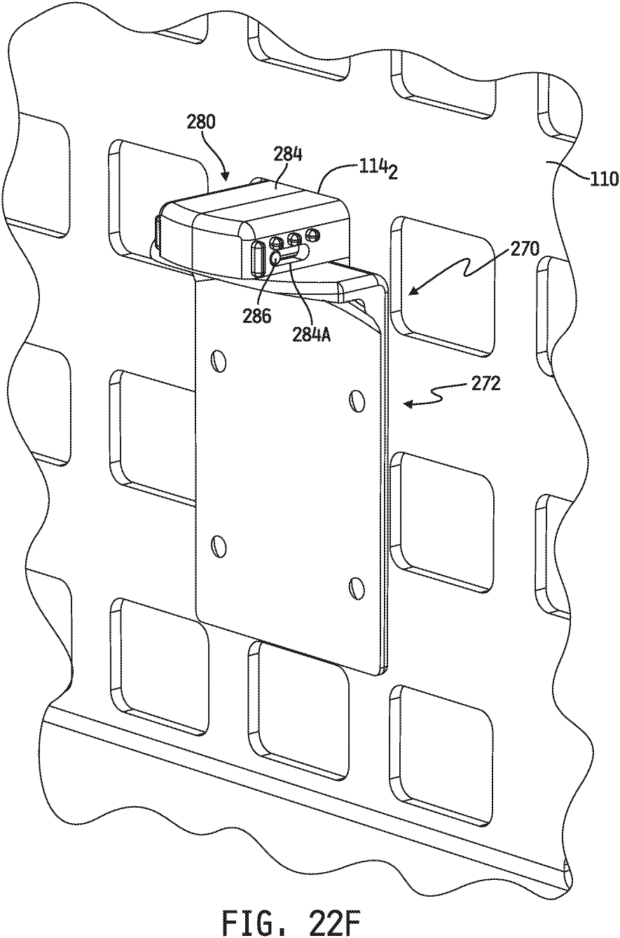

Referring now to FIGS. 22A-22F, still another embodiment of a cargo restraint module 270 is shown mounted to the lattice structure 110. In the illustrated embodiment, the cargo restraint module 270 is configured to receive and restrain a cargo strap module 290 which includes a length of flexible web 292 coiled about and within a case or housing 294. The cargo strap module 290 is received by the cargo restraint module 270 by positioning the cargo strap module 290 on a mounting bracket 272 of the restraint module 270. In some embodiments, a rear face of the cargo strap module 290 includes one or more clips or similar structures and the mounting bracket 272 illustratively includes one or more, e.g., four, receiving structures 272C each configured to engage and couple to a corresponding one of the clips or similar structures of the cargo strap module 290. In any case, with the cargo strap module 290 so received, the cargo restraint module 270 is operable to restrain the cargo strap module 290 relative to the lattice structure 110 and thus relative to the truck bed 16.

The cargo restraint module 270 is similar in structure and operation to the cargo restraint modules 170 illustrated in FIGS. 15A-15E and 170′ illustrated in FIGS. 16A-16G. In the illustrated embodiment, for example, the cargo restraint module 270 includes a mounting bracket 272 having a lattice mounting portion 272A and a securement assembly support portion 272B extending away from a top end of the lattice mounting portion 272A. The receiving structures 272C illustrated in FIG. 22B and described above are illustratively defined by or attached to the lattice mounting portion 272A. In any case, generally L-shaped brackets 274A and 274B extend rearwardly from the lattice mounting portion 272A of the mounting bracket 272. The brackets 274A, 274B are illustratively sized and configured to be received within adjacent openings 114₂, 114₁ defined through the lattice, and slots are illustratively defined between the mounting portion 272A and each of the brackets 274A, 274B, wherein the slots are sized and configured to receive portions of the lattice structure 110 therein as the brackets 274A, 274B are mounted to the lattice structure as described above with respect to FIGS. 15A-16G.

The cargo restraint module 270 further illustratively includes a securement assembly 280 operatively mounted to the securement assembly mounting portion 272B of the mounting bracket 272 and configured to selectively secure the mounting bracket 272 to the lattice structure 110. The securement assembly 280 illustratively includes a cover or housing 1284 slidably mounted to the securement assembly mounting portion 272B via a pin-retaining member or block 282 affixed to the securement assembly mounting portion 272B. As best seen in FIGS. 22B and 22F, a guide pin 286 carried by the block 282 extends through slots 284A defined through side walls of the housing 284 (only one slot shown in FIGS. 22B, 22F, the remaining slot shown in FIGS. 22D and 22E). A biasing member 288, e.g., a coil spring, extends between the block 282 and an inner wall 284B of the housing 284. An outer wall 284C is positioned beyond of the inner wall 284B such that the inner wall 284B is positioned between the block 282 and the outer wall 284C. Illustratively, the block 282, the inner wall 284B and the outer wall 284C all define planes parallel with one another with all such planes parallel with a plane defined by the major planar surface of the lattice structure 110. The biasing member 288 illustratively biases the outer wall 284C rearwardly, i.e., toward the lattice structure 110 when mounted thereto.

The securement assembly 280 of the cargo restraint module 270 is movable, relative to the securement assembly mounting portion 272B of the mounting bracket 272, between engaged and disengaged positions of the securement assembly 280 relative to the mounting bracket 272 and relative to the lattice structure 110. Referring to FIGS. 22B and 22D, for example, the cargo restraint module 270 is mounted to the lattice structure 110 by inserting the brackets 274A, 274B into the openings 114₂, 114₁ respectively defined through the lattice structure 110. As the brackets 274A, 274B enter the openings 114₂, 114₁ respectively, the solid body portion of the lattice structure 110 defined between the openings 114₂, 114₁ contacts the outer wall 284C of the securement assembly 280 and forces the housing 284 of the securement assembly 280 forwardly away from the lattice structure 110 to the disengaged position of the securement assembly 280 as the inner wall 284B of the housing compresses the biasing member 288 against the block 282 as best shown in FIG. 22D.

From the position of the cargo restraint module 270 illustrated in FIGS. 22B and 22D, the brackets 274A, 274B are forced downwardly such that the slots defined between the brackets 274A, 274B and the mounting portion 272A of the mounting bracket 272 pass over the body portions of the lattice structure 110 located below the respective openings 114₂, 114₁. As illustrated in FIGS. 22E and 22F, as the slots pass over the body portions of the lattice structure 110 located below the respective openings 114₂, 114₁, the bias of the compressed biasing member 288 acting against the inner wall 284B forces the outer wall 284C rearwardly into the upper portion of the opening 114₂ vacated by the bracket 274A as the bracket 274A. The resulting position of the securement assembly 280 illustrated in FIGS. 22E and 22F is the engaged position of the securement assembly 280. In this engaged position, the portion of the housing 284 between the inner wall 284B and the outer wall 284C occupies the upper portion of the opening 114₂ and prevents movement of the cargo restraint module 270 relative to the lattice structure 110 to a position in which the brackets 274A, 274B would align with the respective openings 114₂, 114₁ defined through the lattice structure 110, thus securing the cargo restraint module 270 to the lattice structure 110.

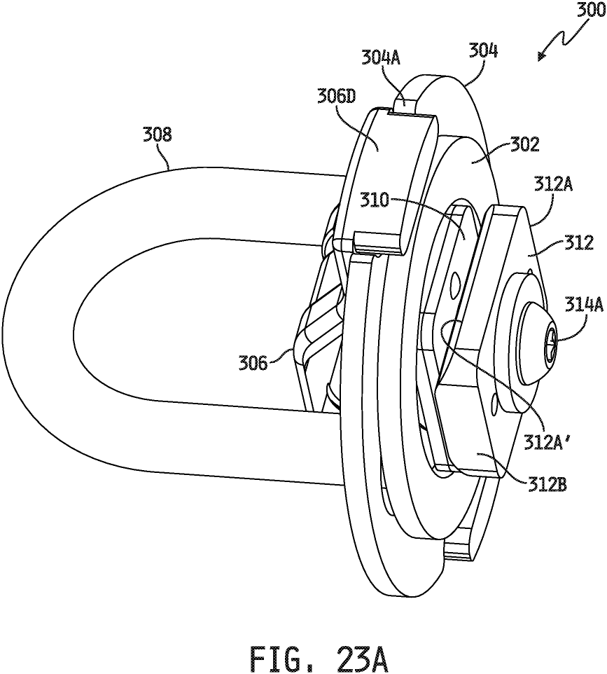

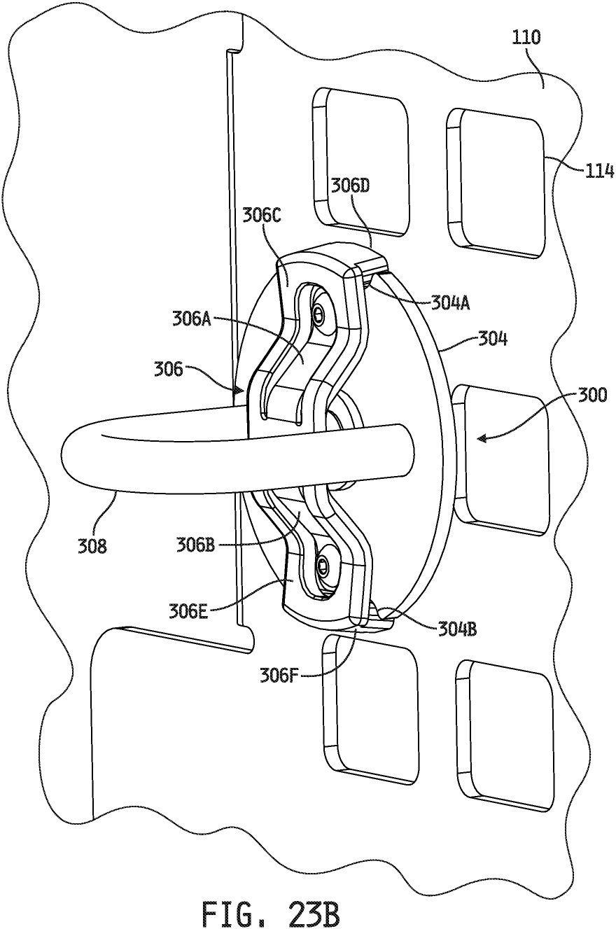

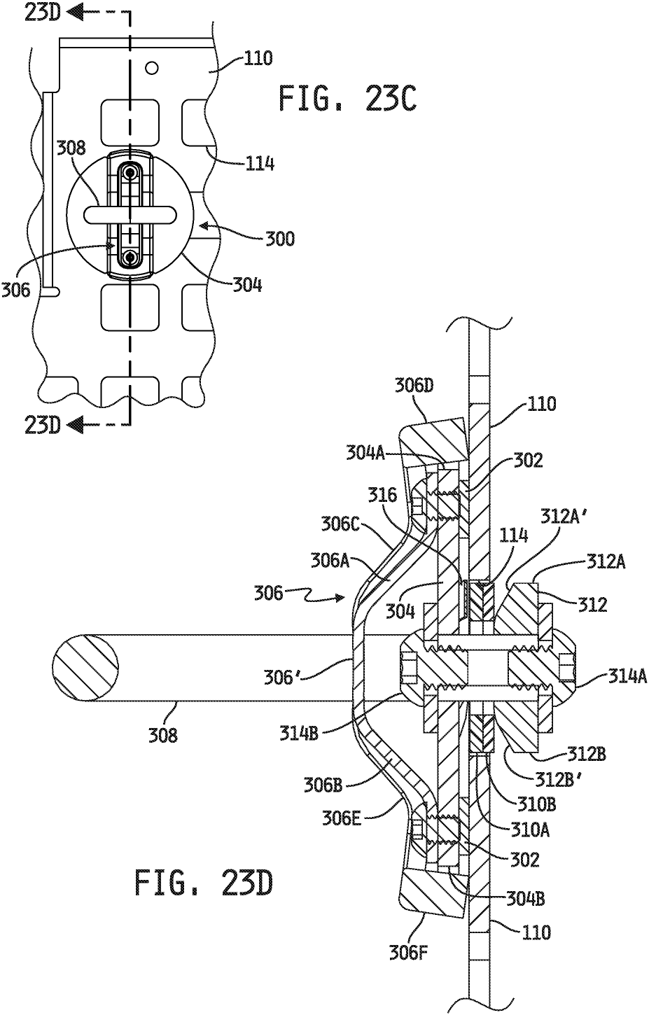

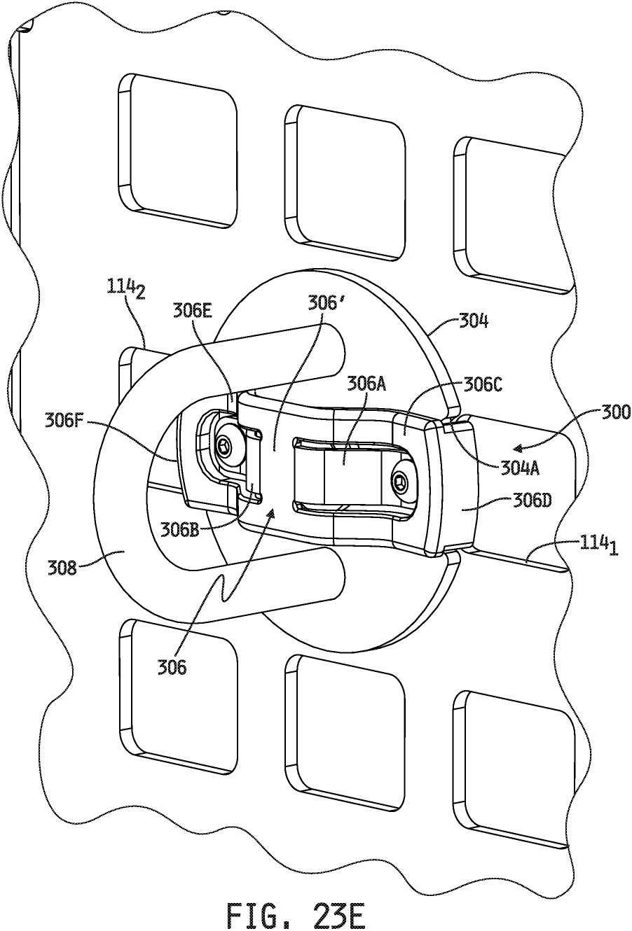

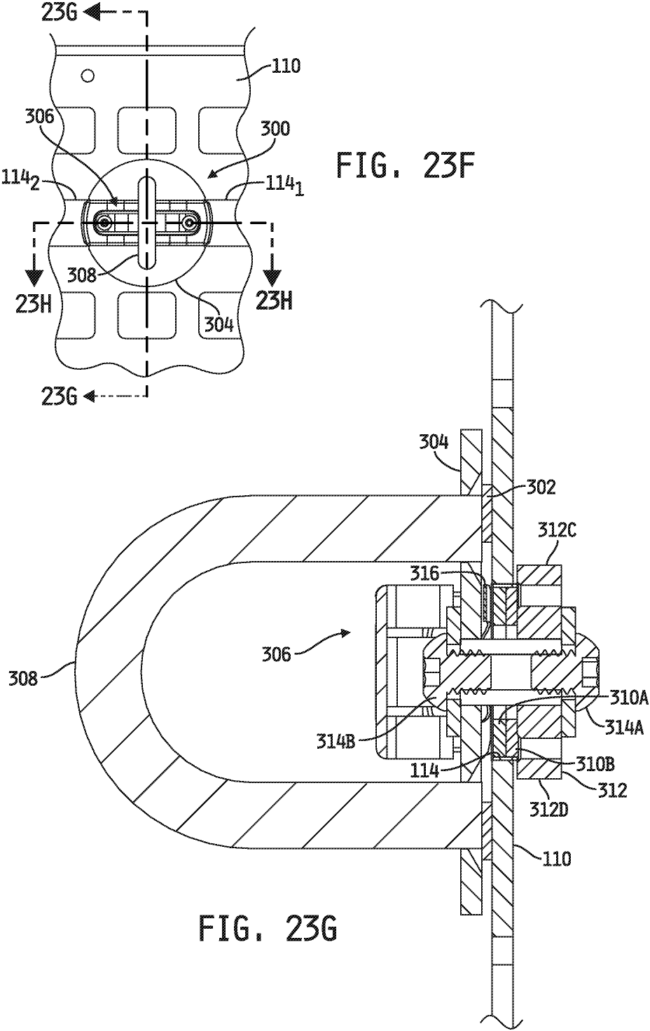

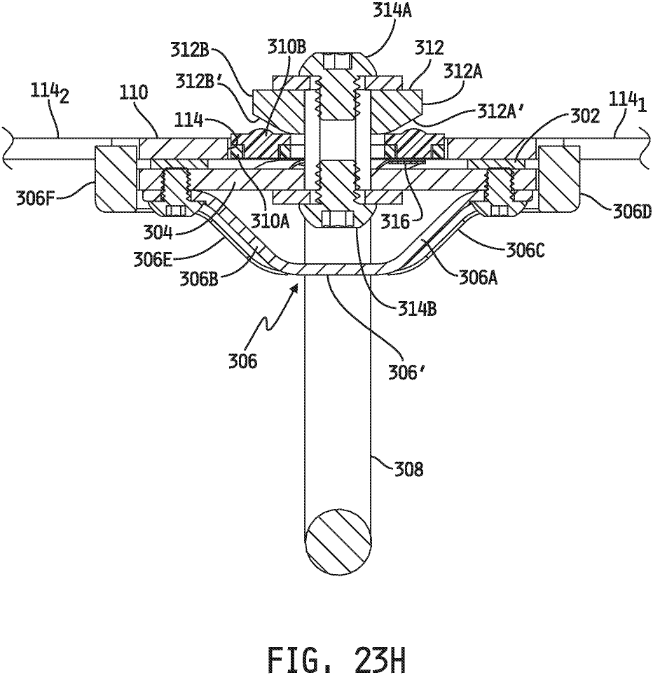

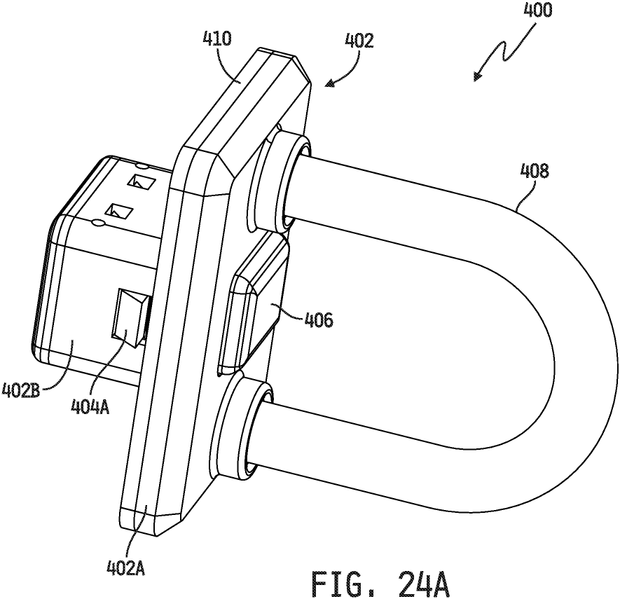

Referring now to FIGS. 23A-23H, yet another embodiment of a cargo restraint module 300 is shown mountable to the lattice structure 110. In the illustrated embodiment, the cargo restraint module 300 is provided in the form of a mounting plate 302 coupled to a number of mounting components 304-306, 310-316 together configured to mount the module 300 to the lattice structure 110. The mounting plate 302 is also coupled to a connection structure 308, e.g., a ring or loop, configured to couple to an engagement structure(s) 20D of one or more cargo restraint modules 18, 18′, 18‴ and/or to any releasably engageable connector such as a hook, clip or other suitable structure.

The mounting plate 302 is illustratively a flat, annular member to which two ends of the connection structure 308 are attached such that the connection structure 308 and the plate 302 together illustratively form a closed path. In some alternate embodiments, the connection structure 308 may be configured so as to be attached to the mounting plate 302 but such that the connection structure 308 and the plate 302 do not together form a closed path. In any case, an anti-rotation guide plate 304 is affixed to a planar surface of the mounting plate 302. The anti-rotation guide plate 304 is illustratively circular in shape and defines a pair of opposed notches 304A, 304B which extend into an outer periphery of the plate 304 such that the notches 304A, 304B are opposite one another, i.e., 180 degrees from one another. An anti-rotation clip 306 is mounted to the guide plate 304 and includes a pair of base arms 306A, 306B each extending from a central body portion 306’ of the clip 306 toward a respective one of the notches 304A, 304B. The base arm 306A terminates short of the slot 304A, and is secured adjacent to its terminal end to the guide plate 304, e.g., via a conventional fixation element. The base arm 306B likewise terminate short of the slot 304B, and is secured adjacent to its terminal end to the guide plate 304, e.g. via a conventional fixation element. A resilient arm 306C extends from the central body portion 306′ of the clip 306 toward the slot 304A, and defines a tooth 306D which extends into the slot 304A, and another resilient arm 306E likewise extends from the central body portion 306′ of the clip 306 toward the slot 304B, and defines another tooth 306F which extends into the slot 304B.

On an opposite side of the mounting plate 302, a spring wave washer 316 is received within the central opening of the plate 302 such that the washer 316 is in contact with the inner surface of the anti-rotation guide plate 304. A pair of spacers 310A, 310B are received within the central opening of the plate 302 with the spacer 310A in contact with the spring wave washer 316 and the spacer 310B in contact with the spacer 310A. A securement plate 312 is received over the spacer 310B, and the plates 304, 312 are secured together via conventional fixation elements 314A, 314B with the spring wave washer 316 and the spacers 310A, 310B disposed therebetween. The securement plate 312 is illustratively rectangular in shape having inwardly beveled edges 312A′, 312B′ along the opposed short sides 312A, 312B respectively, and non-beveled edges along the opposed long sides 312C, 312D. As depicted by example in FIGS. 23C and 23F, the openings 114 defined through the lattice structure 110 are likewise rectangular. The securement plate 312 is illustratively sized and configured such that the securement plate 312 will pass through any of the openings 114 with the plate 312 oriented such that the short sides 312A, 312B are adjacent to the short sides of an opening 114 and the long sides 312C, 312D are adjacent to the long sides of the opening 114, but such that the securement plate 312 will not pass through an opening 114 with the plate oriented such that the short sides 312A, 312B are adjacent to the long sides of an opening 114 and the long sides 312C, 312D are adjacent to the short sides of the opening 114.

The cargo restraint module 300 is movable, relative to the lattice structure 110, between engaged and disengaged positions of the module 300. For example, the cargo restraint module 300 is illustratively securable to the lattice structure 110 by passing the securement plate 312 through one of the openings 114, and then rotating the module 300 90 degrees (in either direction) to trap the body portion of the lattice 110 on either side of the opening 114 between the mounting plate 302 and the securement plate 312. Rotating the module 300 90 degrees as just described further illustratively causes the teeth 306D, 306F of the anti-rotation clip 306 to engage edges of openings 114₁, 114₂ on either side of the opening 114 in which the securement plate 312 is disposed to prevent the module 300 from rotating relative to the lattice structure 110 once secured thereto. Disengaging the teeth 306D, 306E from the openings 114₁, 114₂ and rotating the module 300 90 degrees in either direction allows the securement plate 312 to be withdrawn from the opening 114, thus disengaging the module 300 from the lattice structure 110.

Referring to FIGS. 23B-23D, for example, the cargo restraint module 300 is mounted to the lattice structure 110 by orienting the securement plate 312 to pass into an opening 114 of the lattice structure 110. As the securement plate 312 passes into the opening 114, the solid body portion of the lattice structure 110 defined above and below the opening 114 into which the securement plate 312 passes contacts the teeth 306D, 306F of the anti-rotation clip 306 of the securement assembly 280 and forces the corresponding resilient arms 306C, 306E to flex outwardly so that the edges of the teeth 306D, 306F ride on and along the solid body portion of the lattice structure 110 as the module 300 is thereafter rotated.

From the disengaged position of the cargo restraint module 300 illustrated in FIGS. 23B-23D, the module 300 is rotated 90 degrees in either direction to the engaged position as illustrated in FIGS. 23E-23H. As the module 300 rotates, the solid body portion of the lattice structure 110 above and below the opening 114 become trapped between the long edges 312C, 312D of the securement plate 312 and the mounting plate 302 of the module 300. The components 302, 310A, 310B, 312 and 316 are illustratively sized and configured so as to form a tight fit of the solid body portion of the lattice structure 110 between the securement plate 312 and the mounting plate 302. For example, the spring wave washer 316 compresses as the module 300 is rotated, thereby facilitating engagement of the solid body portion of the lattice structure 110 between the plates 302, 312. Likewise, the inner beveled edges 312A′, 312B′ further facilitate the transition from the disengaged position to the engaged position of the module 300. Further still, in some embodiments, the spacers 110A, 110B are illustratively formed of a low-friction material to further facilitate such engagement. One example material from which the spacers 110A, 110B may be formed is polyoxymethylene, although other low-friction materials or material combinations may alternatively be used. In some embodiments, the spacers 110A, 110B may be merged into a single spacer. In any case, with the module 300 rotated such that the solid body portion of the lattice structure 110 above and below the opening 114 is trapped and engaged between the long edges 312C, 312D of the securement plate 312 and the mounting plate 302, the module 300 is in the engaged position relative to the lattice structure 110 as best shown in FIG. 23G.

As further depicted in FIGS. 23E and 23H, rotation of the module 300 to the engaged position also causes the teeth 306D, 306F of the resilient arms 306C, 306E respectively to ride along the face of the lattice 110 until the teeth 306D, 306F align with the openings 114₁, 114₂ on either side of the opening 114 in which the securement plate 312 is disposed. Once aligned, the bias of the resilient arms 306C, 306E forces the teeth 306D, 306F into the respective openings 114₁, 114₂, thereby preventing the module 300 from thereafter rotating in either direction relative to the lattice structure 110. To disengage the module 300 from the lattice structure 110, a downward force is applied to the top surface of the central portion 306′ of the anti-rotation clip 306 that is greater than the biasing forces of the resilient arms 306C, 306E, which causes the resilient arms 306C, 306E to move away from the lattice structure 110 and thus withdraw the teeth 306D, 306F from the openings 114₁, 114₂. The module 300 is then rotated 90 degrees in either direction to align the securement plate 312 relative to the opening 114 for extraction of the plate 312 and attendant disengagement of the module 300 from the lattice structure 110.

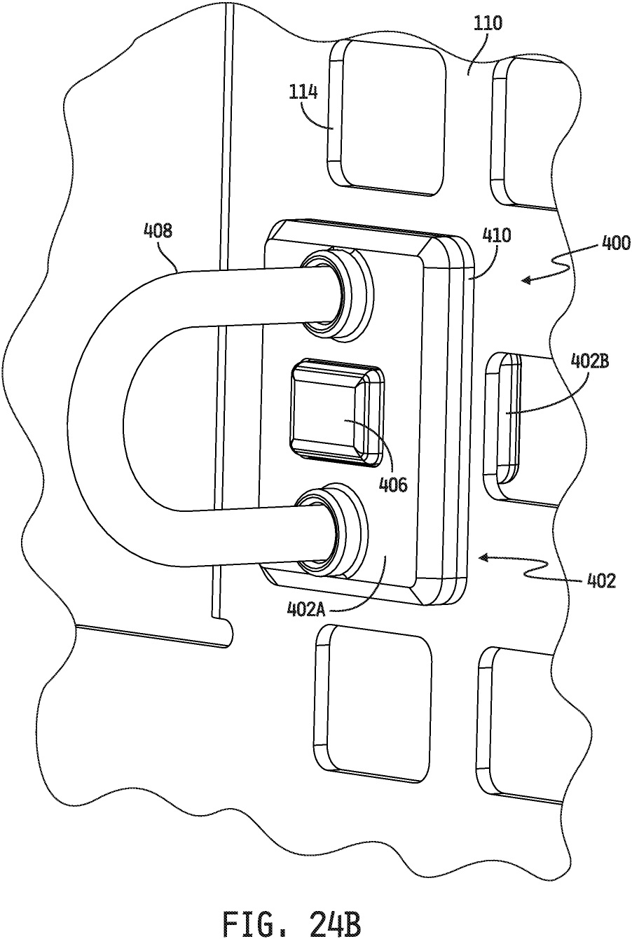

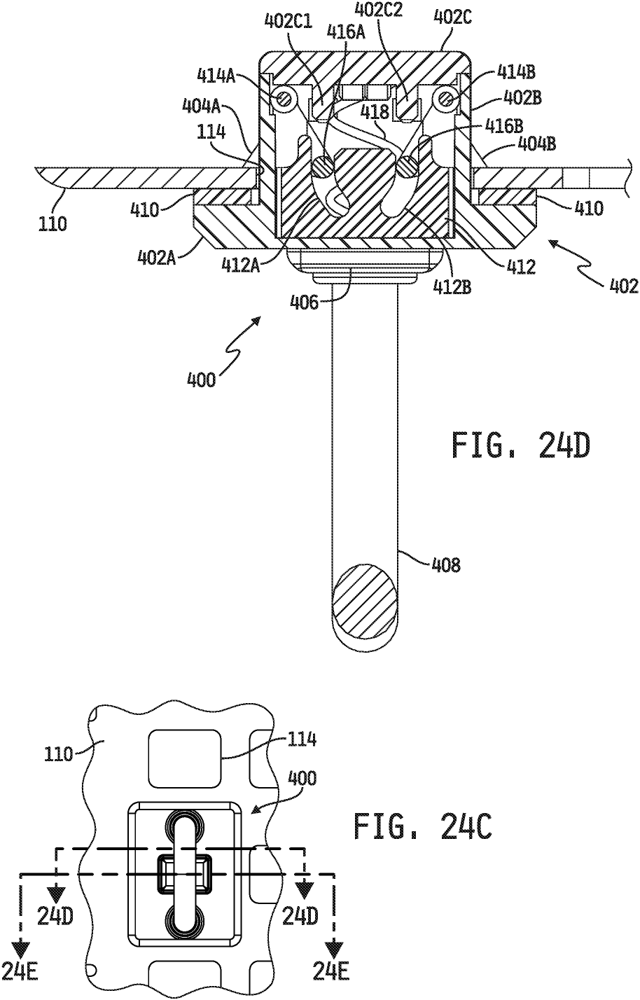

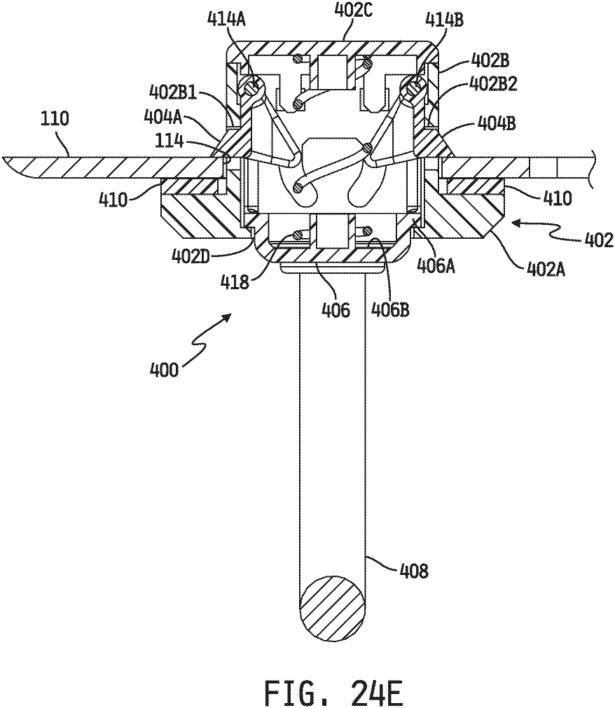

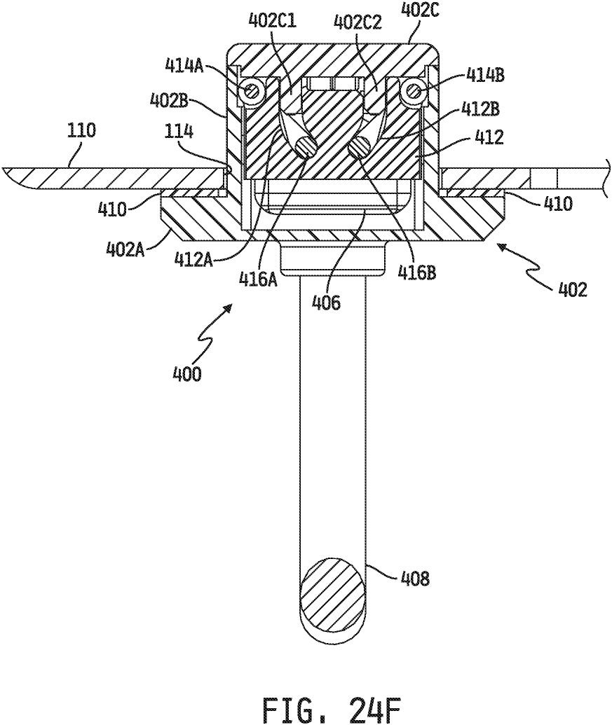

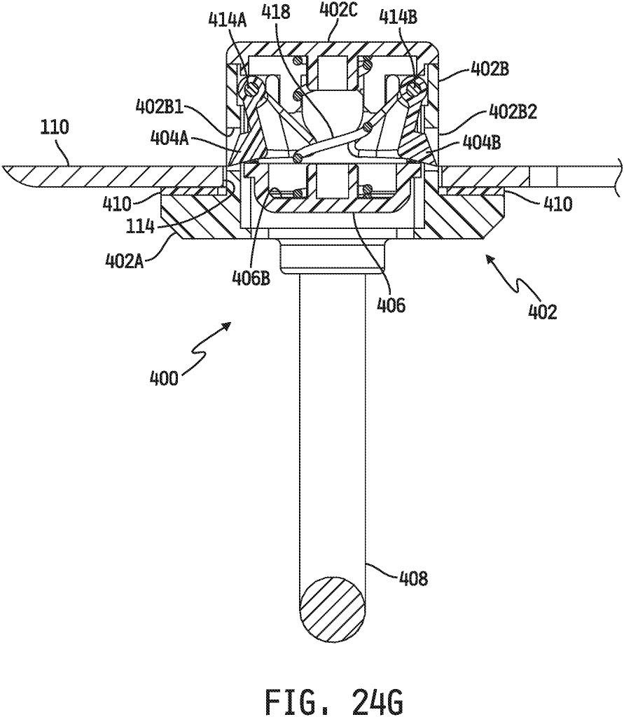

Referring now to FIGS. 24A-24G, still another embodiment of a cargo restraint module 400 is shown mountable to the lattice structure 110. In the illustrated embodiment, the cargo restraint module 400 is provided in the form of a housing 402 operatively coupled to a number of mounting components 404A, 404B, 406 together configured to selectively mount the module 400 to the lattice structure 110. The housing 402 is also coupled to a connection structure 408, e.g., a ring or loop, configured to couple to an engagement structure(s) 20D of one or more cargo restraint modules 18, 18′, 18‴ and/or to any releasably engageable connector such as a hook, clip or other suitable structure.

The housing 402 illustratively includes a substantially planar base portion 402A having a top surface and an oppositely-facing bottom surface from which a peripheral wall 402B extends to an open end of the housing 402. A bottom wall 402C is fixed to and covers the open end of the peripheral wall 402B, and a pair of posts 402C1, 402C2 extend away from an inner surface of the bottom wall 402C. Openings 402B1, 402B2 are defined through opposite sides of the peripheral wall 402B. Illustratively, the peripheral wall 402B is rectangular in shape and is configured to be received within any of the rectangular openings 114 defined through the lattice structure 110. The base portion 402A is illustratively also rectangular in shape and is sized larger than the peripheral wall 402B such that the base portion 402A cannot pass through any of the openings 114. A planar spacer 410 is illustratively coupled to an underside of the base portion 402A about the periphery of the peripheral wall 402B. The planar base portion 402A defines an opening 402D therethrough sized to receive a portion of an actuator button 406 therein. The actuator button 406 illustratively defines a flange 406A thereabout which extends beyond the edges of the opening 402A to thereby limit travel of the actuator button 406. A biasing member 418, e.g., a coil spring, extends between the bottom wall 402C and an underside 406B of the actuator button 406, and operates to bias the actuator button 406 toward and into contact with the base portion 402A adjacent to the opening 402D thereof.

Securement tabs 404A, 404B are pivotably mounted to and within the peripheral wall portion 402B of the housing 402. The securement tab 404A is illustratively rotatable about a pin or shaft 414A mounted to the peripheral wall portion 402B adjacent to the opening 402B1 such that a portion of the securement tab 404A is rotatable into and out of the opening 402B1, and the securement tab 404B is rotatable about a pin or shaft 414B mounted to the peripheral wall portion 402B adjacent to the opening 402B2 such that a portion of the securement tab 404B is rotatable into and out of the opening 402B2. The securement tabs 404A, 404B are illustratively biased, relative to the pins or shafts 414A, 414B, to bias portions of the securement tabs 404A, 404B out of the openings 402B1, 402B2.

The actuator button 406 is illustratively coupled to a guide plate 412 such that the guide plate 412 moves with the actuator button 406 relative to the housing 402. The guide plate 412 defines a pair of guide channels 412A, 412B. A guide pin 416A coupled to the securement tab 404A is received within the guide channel 412A, and a guide pin 416B coupled to the securement tab 404B is received within the guide channel 412B. As the actuator button 406 moves relative to the housing 402, the guide channels 412A, 412B act on the guide pins 416A, 416B to guide the securement tabs 404A, 404B between engaged and disengaged positions relative to the peripheral wall portion 402B of the housing 402.

The cargo restraint module 400 is actuatable between engaged and disengaged positions to engage and disengage the lattice structure 110. For example, the cargo restraint module 400 is illustratively securable to the lattice structure 110 by passing the peripheral wall 204B through one of the openings 114. The biasing member 218 normally biases the actuator button 406 into engagement with the base portion 402A of the housing 402 adjacent to the opening 402D. In this position, the guide channels 412A, 412B act on the guide pins 416A, 416B to force portions of the securement tabs 404A, 404B out of the openings 402B1, 402B2 as illustrated in FIG. 24A. However, as the peripheral wall 204B of the module 400 is passed through an opening 114 of the lattice structure 110, the edges of the lattice structure 110 defining the opening 114 contact the securement tabs 404A, 404B and force the securement tabs 404A, 404B into the openings 402B1, 402B2, which draws the guide pins 416A, 416B toward and out of the open ends of the guide channels 412A, 412B. As the openings 402B1, 402B2 clear the edges of the lattice structure about the opening 114, the securement tabs 404A, 404B are biased outwardly to force the portions of the securement tabs 404A, 404B out the openings 402B1, 402B2 to secure the module 400 to the lattice structure 110. As illustrated by example in FIGS. 24B, 24D and 24E, this is the engaged position of the cargo restraint module 400.

From the engaged position of the cargo restraint module 400 illustrated in FIGS. 24B, 24D and 24E, the module 400 can be disengaged from the lattice structure 110 by pressing the actuator button 406 with a force greater than the biasing force of the biasing member 418 so as to move the button 406 into the housing 402. As the button 406 advances into the peripheral housing portion 402B, the guide channels 412A, 412B act on the guide pins 412A, 412B to draw the securement tabs 404A, 404B completely into the openings 402B1, 402B2 as illustrated in FIGS. 24F and 24G. In the fully depressed position of the actuator button 406, the posts 402C1, 402C1 enter the guide channels 412A, 412B as depicted in FIG. 34F. With the securement tabs 404A< 404B fully drawing into the peripheral portion 402B of the housing 402, the module 400 can be removed from the opening 114 of the lattice structure 110.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1. A securement system for securing cargo items in and to a cargo area of a motor vehicle, the securement system comprising:
an elongated support rail configured to be mounted to an inner wall of any of a side, front or rear of the cargo area of the motor vehicle, the elongated support rail extending along at least a portion of a length of the inner wall, and
a cargo restraint module securable to the elongated support rail at any of a plurality of positions along the elongated support rail, the cargo restraint module including a mounting assembly configured to be releasably secured to the support rail, and a web retractor attached to the mounting assembly, the web retractor configured to pay out and take up a flexible web coupled thereto,
wherein the mounting assembly includes:
a first bracket section to which the web retractor is attached,
a second bracket section,
a hinge coupled between the first and second bracket sections, and
means for securing the second bracket section to the elongated support rail such that the first bracket section is pivotable about the hinge relative to the elongated support rail.

2. The securement system of claim 1, wherein the web retractor is a ratcheting web retractor comprising:
a frame having spaced-apart sidewalls,
a spool coupled to and extending between the sidewalls, wherein one end of the flexible web is attached to the spool, and wherein the spool is rotatable relative to the sidewalls in a web payout direction to pay out web from the retractor and in a web take up direction to take up web in the retractor.

3. The securement system of claim 2, wherein the web retractor is a ratcheting web retractor and further comprises a handle rotatably coupled to the sidewalls, the handle rotatable between first and second positions thereof relative to the sidewalls to take up the flexible web onto the spool.

4. -5. (canceled)

6. The securement system of claim 1, further comprising at least one magnet coupled to the first bracket section for magnetically coupling the first bracket section to the inner wall of the cargo area of the motor vehicle.

7. The securement system of claim 1, further comprising an engagement member coupled to a free end of the flexible web.

8. The securement system of claim 7, further comprising at least one magnet coupled to the engagement member for magnetically coupling the engagement member to the inner wall of the cargo area of the motor vehicle.

9. (canceled)

10. A securement system for securing cargo items in and to a cargo area of a motor vehicle, the securement system comprising:
an elongated support rail configured to be mounted to an inner wall of any of a side, front or rear of the cargo area of the motor vehicle, the elongated support rail extending along at least a portion of a length of the inner wall, wherein the elongated support rail defines a channel therein and extending longitudinally along the elongated support rail,
a mounting assembly, and
a web retractor attached to the mounting assembly, the web retractor configured to pay out and take up a flexible web coupled thereto,
wherein the mounting assembly includes:
a mounting frame attached to the frame of the web retractor,
a locking and release handle or button movably coupled to the mounting frame, and
a rail engagement member movably mounted to the mounting frame and operatively coupled to the locking and release handle or button, the rail engagement member configured to be received within the channel of the elongated support rail,
wherein the locking and release handle or button and the rail engagement member are both normally biased to a rail engagement position in which, with the rail engagement member received within the channel of the elongated support rail, the rail engagement member is secured to the elongated support rail, the rail engagement member responsive to movement of the locking and release handle or button from the rail engagement position to a release position to move from the rail engagement position of the rail engagement member to a rail disengagement position of the rail engagement member in which, with the rail engagement member received within the channel of the elongated support rail, the rail engagement member disengages the elongated support rail so as to be movable along and relative to the elongated support rail.

11. The securement system of claim 10, wherein the elongated support rail defines a plurality of notches spaced apart longitudinally along the support rail,
and wherein the rail engagement member includes a detent configured to extend, with the rail engagement member received within the channel of the elongated support rail, into any of the plurality of notches aligned therewith in the rail engagement position of the rail engagement member to secure the rail engagement member to the elongated support rail.

12. The securement system of claim 11, wherein the rail engagement member is responsive to movement of the locking and release handle or button from the rail engagement position to a release position to withdraw, with the rail engagement member received within the channel of the elongated support rail, the detent from the one of the plurality of notches aligned therewith so that the rail engagement member is thereafter movable along and relative to the elongated support rail.

13. The securement system of claim 10, wherein the web retractor is a ratcheting web retractor comprising a frame a spool rotatably mounted to the frame and a handle rotatably mounted to the frame, wherein one end of the flexible web is attached to the spool, and wherein the handle is rotatable between first and second positions relative to frame to take up the flexible web onto the spool,
and wherein the locking and release handle or button comprises the locking and release handle and is positioned proximate to the handle of the web retractor such that the locking and release handle and the handle of the web retractor are simultaneously grippable by a human hand.

14. -16. (canceled)

17. The securement system of claim 10, wherein the locking and release handle or button handle comprises the locking and release button and is positioned on the mounting frame adjacent to the web retractor.

18. The securement system of claim 10, further comprising:
at least one lattice structure configured to be mounted to, or to define, an inner wall of at least one of the side, front or rear of the cargo area of the motor vehicle, the at least one lattice structure defining a plurality of openings therethrough, and
at least another a cargo restraint module configured to be releasably secured to the at least one lattice structure with at least a first portion of the at least another cargo restraint module extending through at least one of any of the plurality of openings defined through the at least one lattice structure and engaging the at least one lattice structure at least partially about the at least one of the plurality of openings, at least a second portion of the at least another cargo restraint module configured to releasably engage at least one cargo item to restrain the at least one cargo item to and within the cargo area of the motor vehicle.

19. The securement system of claim 18, wherein the elongated support rail is mounted above the at least one lattice structure relative to the inner wall of the cargo area of the motor vehicle.

20. A cargo securement system for securing cargo items in and to a cargo area of a motor vehicle, the cargo securement system comprising:
at least one lattice structure configured to be mounted to, or to define, an inner wall of at least one of a side, front or rear of the cargo area of the motor vehicle, the at least one lattice structure defining a plurality of openings therethrough, and
at least one cargo restraint module configured to be releasably secured to the at least one lattice structure with at least a first portion of the at least one cargo restraint module extending through at least one of any of the plurality of openings defined through the at least one lattice structure and engaging the at least one lattice structure at least partially about the at least one of the plurality of openings, at least a second portion of the at least one cargo restraint module configured to releasably engage at least one cargo item to restrain the at least one cargo item to and within the cargo area of the motor vehicle.

21. The cargo securement system of claim 20, wherein the at least one lattice structure is configured to extend along a length of the inner wall of the at least one of the side, front or rear of the cargo area of the motor vehicle.

22. The cargo securement system of claim 20, wherein the at least one lattice structure is configured to extend along a height of the inner wall of the at least one of the side, front or rear of the cargo area of the motor vehicle.

23. The cargo securement system of claim 20, further comprising at least one elongated support rail configured to be mounted to the inner wall of the at least one of the side, front or rear of the cargo area of the motor vehicle, the at least one elongated support rail extending along at least a portion of a length of the at least one lattice structure at or adjacent to a top edge thereof, and
at least another cargo restraint module configured to be releasably secured to the at least one support rail, at least a portion of the at least another cargo restraint module configured to releasably engage the at least one or at least another cargo item to restrain the at least one or the at least another cargo item to and within the cargo area of the motor vehicle.

24. -27. (canceled)

28. The securement system of claim 1, further comprising:
at least one lattice structure configured to be mounted to, or to define, an inner wall of at least one of the side, front or rear of the cargo area of the motor vehicle, the at least one lattice structure defining a plurality of openings therethrough, and
at least another a cargo restraint module configured to be releasably secured to the at least one lattice structure with at least a first portion of the at least another cargo restraint module extending through at least one of any of the plurality of openings defined through the at least one lattice structure and engaging the at least one lattice structure at least partially about the at least one of the plurality of openings, at least a second portion of the at least another cargo restraint module configured to releasably engage at least one cargo item to restrain the at least one cargo item to and within the cargo area of the motor vehicle.

29. The securement system of claim 28, wherein the elongated support rail is mounted above the at least one lattice structure relative to the inner wall of the cargo area of the motor vehicle.

30. The cargo securement system of claim 28, wherein the at least one lattice structure is configured to extend along a length of the inner wall of the at least one of the side, front or rear of the cargo area of the motor vehicle.
